(19) United States
(12) Patent Application Publication
(10) Pub. No.: US 2008/0319918 A1
(43) Pub. Date: Dec. 25, 2008

(54) Methods and systems for generating product offers over electronic network systems

(75) Inventor: Luigi Forlai, Rome (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kyklos Entertainment S.r.I.

(21) Appl. No.: 12/149,731

(22) Filed: May 7, 2008

Related U.S. Application Data
(63) Continuation-in-part of application No. 11/806,803, filed on Jun. 4, 2007.
Application No. 11/806,803 is a division of application No. 09/609,228, filed on Jun. 30, 2000, now Pat. No. 7,243,082.
(60) Provisional application No. 60/141,284, filed on Jun. 30, 1999.

(51) Int. Cl. G06Q 30/00

(52) U.S. Cl. 705/80; 705/14; 705/27; 705/10

(57) ABSTRACT

Methods and systems are provided for advertising and providing product offers. Such methods and systems may be implemented for increasing, for example, advertising revenue or the amount of time spent by individuals viewing a Web site. According to one implementation, a method is provided that includes the steps of receiving information regarding products offered at no cost from one or more vendors, indicating, on a Web site, the availability of at least one of the products for a transient period of time, which is unpredictable by individuals viewing the Web site, and providing at least one of the individuals viewing the Web site with at least one of the products, at a price equal to or less than a delivery cost associated with delivering the at least one product to the at least one individual.

### CROSS REFERENCE TO RELATED APPLICATIONS

The present application is a continuation-in-part of U.S. patent application Ser. No. 11/806,803 (“the '803 application”), filed Jun. 4, 2007, and entitled “Method and Apparatus for Generating a Sale Offer to Selected Individuals Over Electronic Network Systems.” The '803 application is a divisional application of U.S. patent application Ser. No. 09/609,228 (“the '228 application”), filed Jun. 30, 2000, and entitled “Method and Apparatus for Generating a Sale Offer to Selected Individuals Over Electronic Network Systems.” The '228 application, which issued as U.S. Pat. No. 7,243,082, claims priority to U.S. Provisional Patent Application No. 60/141,284, filed Jun. 30, 1999, and entitled “Method and Apparatus for Generating a Sale Offer Over an Electronic Network System.” The disclosures of the above-referenced applications are expressly incorporated herein by reference to their entireties.

### BACKGROUND

I. Technical Field

The present invention generally relates to electronic commerce systems and related methods. More particularly, and without limitation, the invention relates to electronic commerce systems and methods in which a product offer is provided by a vendor and communicated by an offeror to selected consumers through an electronic network system or environment.

II. Background Information

The development of the Internet has brought about a profound effect on price competition for goods and services in the global marketplace. Web sites on the Internet, such as Amazon.com, sell goods at prices substantially less than conventional distributors who typically employ printed advertisements to attract customers. These sites have been able to do so by utilizing the global reach of the Internet to expand the relevant sales market beyond the local market reached by printed advertising methods. Moreover, the start-up costs of setting up a Web site are either less than or at least comparable to the start-up costs associated with conventional sales methods. Accordingly, Web sites have been able to transfer cost savings to the consumer in the form of substantially reduced prices.

Other Web sites have also attempted to further reduce prices. For example, Buy.com has been able to sell software and other goods at below-cost prices by recouping the losses through advertising revenue generated over the site itself. Moreover, some Web sites have allowed consumers to receive free personal computers on the condition that the consumers provide personal data, which could be sold to advertisers. However, many of these endeavors collapse when the cost of procuring such goods outweighs the advertising revenue generated.

In general, conventional consumer transactions are seller-driven, in the sense that they focus on the methods or processes available to the seller. Typically, electronic sales systems involve sellers utilizing various electronic advertising media in order to attract potential consumers and, in some cases, to complete sales transactions. With an electronic sales system, it is possible to reach more potential consumers than with other conventional sales methods (e.g., printed advertising). Electronic sales systems, however, suffer from the same drawbacks of conventional sales methods in that the seller normally absorbs the risk and cost of advertising. That is, the advertising cost associated with the transaction and the attendant risk that such advertising will be unsuccessful fall directly upon the seller. As a result, the retail price of a product will normally include not only the cost of manufacturing the product and the seller's anticipated profit, but also the cost of advertising the product. Similar problems and associated risks exist when a seller offers services.

In U.S. Pat. No. 7,263,505, entitled “Method and Apparatus for Generating a Sale Offer Over An Electronic Network System,” by the present inventor Luigi Forlai, electronic sales systems and methods are disclosed in which a sale offer is communicated from a seller to a buyer through an electronic network system or environment. A sale offer is electronically presented to a consumer through a Web site or electronic network at a substantially discounted price or for “free” (i.e., for free or at a price near zero, plus delivery charges, if applicable) for a very limited amount of time. In one embodiment disclosed therein, any persons who happen to be visiting a particular Web site at a certain point in time will receive an offer for a virtually free good. This point in time (generally referred to as a “Happy Minute®”) may appear on a random basis during the day, so that the consumer does not know when the Happy Minute® starts. As a result, consumers have an incentive to increase their stay and viewing on that particular Web site.

A distinction between this strategy and the economic strategies of prior techniques for selling discounted goods or services, such as on Web sites like Buy.com, is the fact that the latter is continuously selling goods or services with a discount (such as a 10% discount) while, under the Happy Minute® embodiment, the goods or services are, from a consumer's perspective, randomly offered to a consumer for a price equal to or near zero, and for a very limited period of time. In some cases, the cost of each individual sale offer may still be high for the owner or co-owner of the Web site. However, because of the unique and temporary nature of the sale offer, a limited number of products may be passed on to consumers. Moreover, a large number of consumers may crowd the Web site, thus generating a substantial revenue for the owner or co-owner of the Web site. Potentially high revenues may be obtained by selling the associated consumer traffic to advertisers (i.e., through banner sales, etc.). As a result, the high costs of selling products at a price equal to or near zero may be covered by the sales of increasing consumer traffic to an advertising space consumer. Nevertheless, the owner or co-owner of a Web site may still desire to further decrease the costs and/or other risks associated with making such product offers to consumers.

Accordingly, there is a need for improved methods and systems for offering goods and services, including via Web sites and other electronic sales systems, to reduce the risks placed on an offeror. There is also a need for improved methods and systems for advertising goods and services, and reaching more consumers in a fast and economical fashion. Still further, there is a need for improved ways of obtaining goods and services at no cost, or at a low cost, and providing them to consumers in such a way that improves advertising revenue. Moreover, there is a need to provide improved ways for automatically and intelligently directing product offers to a group of selected individuals. Such individuals may be registered as potential consumers from among a larger number of other visitors connected to an electronic sales system in order to, for example, increase the likelihood of acceptance of the product offer.

### SUMMARY

Consistent with certain embodiments of the invention, it is an object to provide improved methods and systems for offering goods or services, including within electronic commerce systems, to reduce the risks placed on an offeror. The offeror may be, for example, an owner or co-owner of a Web site. Further, the goods or services may be obtained at no cost, or at a low cost, such that advertising revenue is increased for the offeror of the Web site.

Additionally, consistent with certain embodiments of the invention, it is an object to provide improved ways of advertising goods or services, and increasing awareness of a vendor's goods or services.

Still further, consistent with certain embodiments of the invention, it is an object to provide improved ways for automatically and intelligently directing product offers to a group of selected individuals. Such individuals may be registered as potential consumers from among a larger number of other visitors connected to an electronic sales system in order to, for example, increase the likelihood of acceptance of the product offer.

In accordance with one embodiment, a method is provided for increasing, for example, the amount of time spent by individuals viewing a Web site. The method includes the steps of receiving information regarding at least one product offered at no cost from one or more vendors; indicating, on a Web site, the availability of the at least one product for a transient period of time, which is unpredictable by individuals viewing the Web site; and providing at least one of the individuals viewing the Web site with the at least one product, at a price equal to or less than a delivery cost associated with delivering the at least one product to the at least one individual.

In accordance with another embodiment, a method is provided for increasing, for example, traffic on a Web site. The method includes the steps of providing a vendor with information regarding the Web site; receiving from the vendor information regarding one or more products offered by the vendor; and providing the vendor with a promise in exchange for receipt of the one or more products. The promise may include promising the vendor that the one or more products will be provided to a visitor of the Web site at a price equal to or less than a delivery cost associated with delivering the one or more products to the visitor.

In accordance with yet another embodiment, a method is provided, for example, for providing a product vendor with targeted advertising. The method includes the steps of providing the product vendor with information regarding a plurality of Web sites; receiving from the product vendor the identity of a preferred one of the Web sites; receiving from the product vendor an offer to provide at least one product at no cost to at least one visitor of the preferred one of the Web sites; and providing the at least one product at no cost to at least one visitor of the preferred one of the Web sites.

Consistent with still another embodiment, a method of increasing targeted product exposure is provided. The method includes the steps of receiving information regarding a plurality of Web sites; selecting a preferred one of the Web sites based on the received information; and providing at least one product to an agent of the preferred one of the Web sites in exchange for a guarantee. The guarantee may include a guarantee from the agent that product information regarding the at least one product will be displayed on the preferred one of the Web sites. Additionally, or alternatively, the guarantee may include a guarantee that the at least one product provided to the agent will be further provided to at least one visitor of the preferred one of the Web sites, at a price equal to or less than a delivery cost associated with delivering the at least one product to the at least one visitor.

In yet another embodiment, a system is provided, for example, for creating an online marketplace. The system includes a communication device configured to receive information about a content Web site from an offeror; and receive information about a product from a vendor; a data storage device; and a processor connected to the data storage device, wherein said storage device stores a program for controlling the processor. The processor is operative with the program for providing a central Web site operable by an administrator; and providing a product display and offer proposal to the offeror and vendor. The product display and offer proposal may include: the offeror displaying the product on the content Web site for a transient period of time unpredictable by consumers visiting the content Web site; the offeror offering the product at no cost to at least one consumer visiting the content Web site; and the vendor supplying the product at no cost to the administrator, the offeror, or the consumer.

In yet another embodiment, a system is provided, for example, for facilitating a sweepstakes over an electronic network system. The system includes a data storage device and a processor connected to the data storage device, wherein said storage device stores a program for controlling the processor. The processor is operative with the program for providing a central Web site operated by an administrator; providing a vendor of products with information about a plurality of content Web sites, via the central Web site; providing an agent for one of the content Web sites with information about products available from the vendor, via the central Web site; displaying the products on one of the content Web sites for a transient period of time unpredictable by visitors to the content Web site; and making an offer to provide the products at no cost to one or more consumers who view the displayed products during the transient period of time.

In accordance with still another embodiment, a method is provided, for example, for enabling an individual to obtain a product from a vendor at a cost substantially below its retail price. The method includes the steps of visiting a Web site operated by an offeror; electronically providing the offeror with personal demographic data; viewing a display of a product on the Web site, the display offering to provide the product to visitors of the Web site at a cost equal to or less than a delivery cost associated with delivering the product to a visitor who accepts the offer; accepting the offer from the offeror; and receiving the product from a vendor that provided the offeror with instructions for displaying the product on the Web site.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described herein and of being practiced and carried out in various ways. Also, it is to be understood that the phraseology and terminology employed herein, as well as the abstract, are for the purpose of description and should not be regarded as limiting.

The accompanying drawings illustrate certain exemplary embodiments of the invention and, together with the description, serve to explain the principles of the invention. As such, those skilled in the art will appreciate that the conception upon which this disclosure is based may readily be utilized as a basis for designing other structures, methods, and systems for carrying out the several purposes of the present invention. It is important, therefore, to recognize that the claims should be regarded as including such equivalent constructions insofar as they do not depart from the spirit and scope of the present invention.

### BRIEF DESCRIPTION OF THE DRAWINGS

The accompanying drawings are included to provide a further understanding of the invention and are incorporated in and constitute a part of this specification. The drawings illustrate embodiments of the invention, and, together with the description, serve to explain the principles of the invention. In the drawings:

FIG. 1 illustrates an exemplary embodiment of an electronic network environment for implementing methods and systems consistent with the present invention;

FIG. 2 illustrates an exemplary embodiment of interaction between entities, consistent with an embodiment of the invention;

FIG. 3 is a block diagram showing an exemplary method, consistent with an embodiment of the invention;

FIG. 4 is a block diagram of another exemplary method, consistent with an embodiment of the invention;

FIG. 5 illustrates an exemplary administrator interface, consistent with an embodiment of the invention;

FIG. 6 is a block diagram showing an exemplary interaction with a portion of the administrator interface of FIG. 5;

FIG. 7 illustrates an exemplary offeror interface, consistent with an embodiment of the invention;

FIG. 8 illustrates an exemplary consumer interface, consistent with an embodiment of the invention;

FIG. 9 illustrates an exemplary vendor interface, consistent with an embodiment of the invention;

FIG. 10A illustrates an exemplary administrator Web site's homepage before a product offer is transmitted from the administrator interface;

FIG. 10B illustrates an exemplary administrator Web site's information page about a product offer;

FIG. 10C illustrates an exemplary consumer registration entry form to be completed by a potential registrant;

FIG. 10D illustrates an exemplary personal data entry form to be completed by a potential consumer;

FIG. 11A illustrates one aspect of the features of an exemplary administrator page for use by the Web site's administrator;

FIG. 11B illustrates another aspect of the features of an exemplary administrator page for use by the Web site's administrator;

FIG. 11C illustrates yet another aspect of the features of an exemplary administrator page for use by the Web site's administrator;

FIG. 12 illustrates an exemplary product display that may appear in an associated Web site's pages for viewing by potential consumers;

FIG. 13 illustrates an exemplary administrator page showing that the administrator interface has received a consumer “sign-in,” automatically assigned a tracking number, and sent an acceptance form;

FIG. 14 illustrates an exemplary product offer that may appear in an associated Web site's information page as received by a potential consumer;

FIG. 15 illustrates an exemplary administrator page showing that the administrator interface has received data from a personal entry data form and automatically sent an acceptance form to the consumer;

FIG. 16 illustrates an exemplary acceptance form received and completed by the consumer;

FIG. 17 illustrates an exemplary credit card data entry form to be completed by the consumer;

FIG. 18 illustrates an exemplary administrator page showing money transfer response data;

FIG. 19 illustrates an exemplary successfully completed transaction page received by a consumer;

FIG. 20 illustrates an exemplary administrator page showing data for a successfully completed transaction;

FIG. 21 illustrates an exemplary unsuccessfully completed transaction page received by a consumer;

FIG. 22 illustrates an exemplary administrator page showing data for an unsuccessfully completed transaction;

FIG. 23 illustrates an exemplary warning message on the associated Web site's page, notifying a consumer that a product offer is no longer available and the transaction is considered null and void;

FIG. 24 illustrates an exemplary sale cancellation announcement received by a potential consumer in response to clicking the “leave” button, indicating that a product offer is no longer available;

FIGS. 25A-C are flow charts of exemplary processes and operations for registering consumers, and obtaining and installing a browser plug-in used in conjunction with the receipt of product offers;

FIG. 26 is a flow chart of an exemplary method and illustrates how an offeror, or content site administrator, may input product offer parameters to generate product offers, receive consumer tracking and contract data, and complete a product offer transaction with a consumer;

FIG. 27 is a flow chart of an exemplary method and illustrates how a potential consumer may interact with an offeror to view and accept product offers; and

FIG. 28 is a flow chart of an exemplary method for generating and accepting a consumer's response to product offers.

### DETAILED DESCRIPTION

Generally, embodiments of the present invention provide methods and systems for offering goods and services in an electronic network environment, such as, for example, the Internet. According to various features and aspects of the invention, any number of vendors and offerors may enter into agreements along with an owner or administrator of a “central Web site,” to generate product offers to consumers. The vendors may be any entities desiring to provide goods or services to consumers at no cost. The offerors may be any entities desiring to increase consumer traffic on “content Web sites” operated by the offerors. The product offers may include offers for goods or services to be provided to consumers visiting content Web sites operated by the offerors, whereby such a consumer may accept and receive the goods or services from the vendors at a deeply discounted price or at virtually no cost.

As used herein, the term “content Web site” is intended to refer to one of any number of associated Web sites that have arranged with an administrator of the “central Web site” to permit product offers to be communicated to consumers who are visiting or browsing any one of the associated content Web sites. In one embodiment, a consumer who is visiting an associated content Web site that features one type of good or service may, nevertheless, receive a product offer from a vendor of a totally different good or service, the only requirement being that both the offeror and vendor have associated with the central Web site and/or administrator.

As used herein, the term “product” is intended to refer to any good or service provided by a vendor to be offered to consumers by an offeror through an associated content Web site. In the context of goods offered by an offeror, a visitor (i.e., the consumer) who accepts a product offer may only be required, for example, to pay a nominal price, with or without delivery charges. Services offered by an offeror may also be offered at a deeply discounted price or on a virtually “free” basis. Since the goods or services are offered on a heavily discounted or free basis, each content Web site hosting the product offer will experience increased traffic or “hits” from visitors connected to the Internet. Moreover, the content Web site may experience visitors spending longer amounts of time on a given Web site (i.e., increased “stickiness”). The product offer, therefore, has value to content Web site owners by providing a means for increasing traffic and/or hits to the content Web sites, thereby increasing the value of the content Web sites and/or increasing e-commerce conducted through the sites. The product offer also provides value to the vendor in the form of an effective means for advertising goods or services over the Internet.

In order to increase and/or maintain the number of visitors to associated Web sites, the goods or services that are offered over such Web sites may be offered at unpredictable or random times. For example, a system administrator may select one or more times during a specific date on which the product offer is to be made on the associated content Web sites. The time(s) at which the product offer is selected by the system administrator may be kept secret from Web site visitors so as to make the offer “unpredictable.” Alternatively, a system administrator may program an administrator interface module, such that a product offer is provided on one or more of the associated content Web sites, in which case the administrator interface may send more than one kind of product offer at the same time. In this case, multiple sets of product offers may be transmitted to two sets of consumers, each one visiting one Web site on behalf of which the product offers are generated. The administrator interface may also be programmed for “randomness” of the product offer, which will also increase and pique interest in the Web sites, as visitors link to and/or browse the Web sites in anticipation of the product offer being displayed or communicated through a visited Web site.

When providing a product offer, each product offer may be made available to all consumers that are presently visiting the associated Web sites and exchanging information with the Web server or administrator interface. In some cases, the capacity of the Web server or administrator interface may be limited so that only a predetermined number of consumers (e.g., 200 consumers) can receive the product offer at any given instant. Alternatively, a limited number of product offers (not necessarily restricted by the capacity of the server or controller) may be provided to registered consumers visiting and exchanging information with the associated Web sites when the offer is to be made. In such a case, the product offer may expire prior to the duration or period of the offer, if all of the predetermined product offers have been accepted by consumers who received the offer through the Web sites. It is also possible to select one or more individual Web sites from all the Web sites that are associated with the central Web site, so that only those Web sites that fit a particular marketing or other business objective will be used to present a product offer to prospective registered consumers. It is also possible to target particular consumers from among all those who are registered, so that only consumers who have a certain profile or other type of identifier that matches a predetermined profile or identifier selected by the offeror can actually receive a product offer. Taken to the extreme, it would also be feasible to so target a small group—or even a single individual—in this manner.

Finally, both features may be combined so that only selected associated Web sites and/or targeted registered (selected or pre-qualified) consumers may be chosen for the product offer to be conveyed on, and made to, respectively. With such targeted approaches, the offeror may target such specific Web sites and/or types of consumers with the product offer.

In one embodiment of the present invention, communication between offerors and consumers is conducted using an electronic network and administrator interface. In a preferred embodiment, the electronic network comprises the Internet. Potential consumers can access the Internet through a variety of devices, such as through a personal computer, an interactive TV device, a wireless phone, a personal digital assistant (PDA), or any other communication device. Associated Web site owners or offerors who wish to make offers may access an administrator interface, which may be implemented through a server, computing system, or module connected to the Internet, through a direct dial-up connection or over the Internet through an Internet service provider, for example. Through the administrator interface, a system administrator for the offeror may create a product offer by specifying the subject of the good or service to be placed on sale, the good's or service's price, the limited time period during which a registered consumer can accept the offer, an acceptance form, and finally a payment identifier. The product offer may then be conveyed over the Internet to each of the Web servers that are associated with the central Web site. Consequently, Web surfers who are registered and who visit any of the Web sites that are so associated will be provided the opportunity to view and respond to the product offer, provided that their visit to the Web site coincides with the time interval during which the product offer is made.

Once the potential consumer has seen the announcement of the product offer and wishes to accept it, the consumer may, through the Web site, accept the product offer. At the same time, the administrator interface “records” that a consumer is going to complete an acceptance form and prevents the acceptance form from disappearing within the predetermined time limit or period.

According to an aspect of the invention, the administrator interface may automatically send the potential consumer a unique tracking number and an acceptance form to fill out with personal data while the consumer is online with the administrator interface. After filling all the required statements of acceptance, the consumer transmits, via the plug-in and through a Web page on the administrator interface, the acceptance form. Under the present invention, the acceptance form can be transmitted via a World-Wide-Web (WWW) interface, electronic mail, or voice mail, not excluding further or future evolutions of communications technology and media, which will provide “instant” or real-time communication between the consumer and the offeror.

As soon as the controller receives all the transmitted consumer data together with the filled out acceptance form, the administrator interface transmits the potential consumer a payment identifier together with a final statement of acceptance to be electronically signed by the consumer and filled out with credit or debit card data or a description of a cash delivery form. After acceptance of this last form, the consumer transmits it, via plug-in and through a web page on the administrator interface in the acceptance form, online to the offeror. The consumer and offeror are now parties to a legally binding contract.

The administrator interface manages the payment system between the offeror and the consumer, and transmits the credit or debit card data to the consumer's bank for confirmation of fund availability and/or card validity. Finally, the administrator interface stores the payment, keeps track of it, and sends a reply to the consumer to ensure him/her of receipt of the payment receipt.

This method may allow Web site owners or offerors to reach a large number of remotely located registered consumers who normally reach Web sites and who would likely be interested in goods and services, those being related to the site's content and offered for a disproportionately low price in comparison to their real market value. The method also provides each associated Web site owner with a robust system to improve the capacity of traffic in the site, which is highly marketable.

In certain cases, a Web site-owner or offeror may desire to further decrease the cost of making product offers to consumers visiting the Web site. Accordingly, consistent with certain embodiments disclosed herein, an offeror may obtain products from a vendor at no cost. Specifically, a vendor may arrange with an owner of a particular Web site for certain products to be offered for free, or at a discounted price, to visitors of content Web sites operated by participating offerors. As further described herein, such embodiments may provide offerors with lower costs associated with making product offers to consumers visiting their respective Web sites. Moreover, such embodiments may provide vendors with increased exposure and targeted advertising for their products.

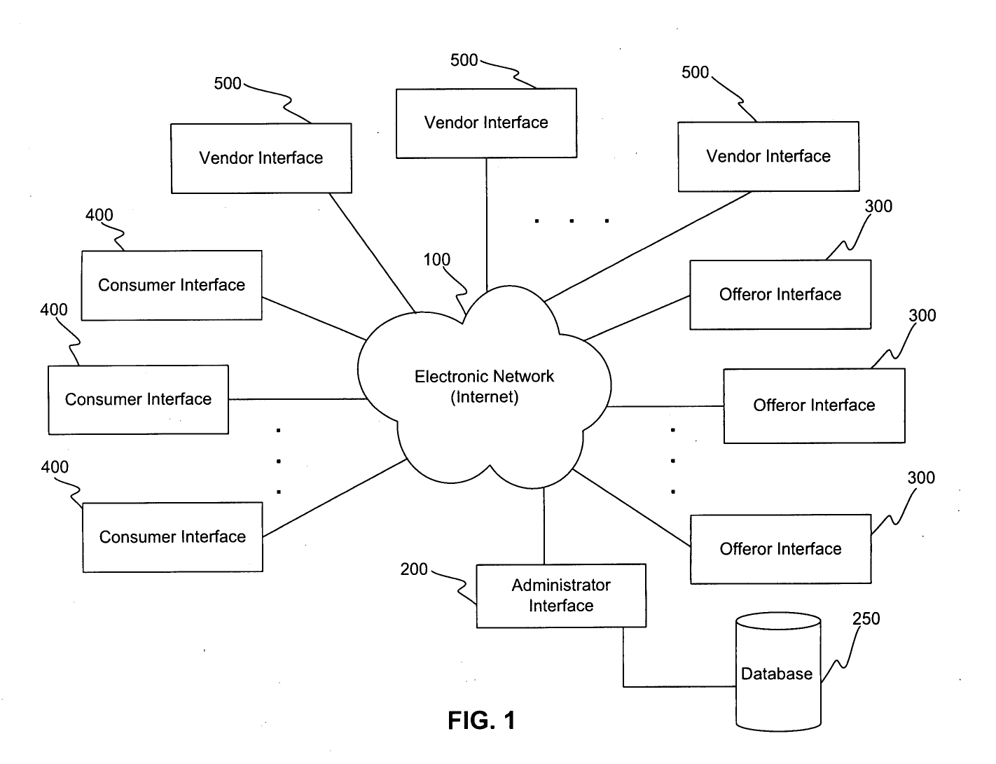

As illustrated in the exemplary network environment of FIG. 1, embodiments the present invention may include an administrator interface 200, one or more offeror interfaces 300, one or more consumer interfaces 400, and one or more vendor interfaces 500. The administrator interface 200 may be associated with an administrator that operates a central Web site. Each offeror interface 300 may be used by an offeror to run a content Web site. In addition, each offeror interface 300 may be used by an offeror to interact with the central Web site. Each consumer interface 400 may be used by a consumer to access the Internet, including one or more content Web sites operated by respective offerors. Each vendor interface 500 may be used by a vendor to interact with the central Web site.

The administrator interface 200, offeror interfaces 300, consumer interfaces 400, and vendor interfaces 500 may also be referred to herein as “nodes.” Direct connections or links may be provided between these nodes or, alternatively, communication between the nodes may be facilitated by an electronic network 100. In the latter case, each node may be connected to the Internet or another suitable network environment using, for example, a modem and a public switched phone network, such as those provided by a local or regional telephone operating company. Other types of network connections are also feasible, such as those facilitated by cable, satellite links, and other types of wired or wireless links. Each offeror interface 300, consumer interface 400, and vendor interface 500 may communicate with administrator interface 200 over the Internet using conventional messaging protocols, such as, for example, the TCP/IP protocol. In actuality, when any individual visits a Web site using a conventional Web browser, such as a Microsoft Internet Explorer Web browser, Mozilla Firefox, or Apple Safari, that individual is connected to a Web server which hosts the Web page being observed by that individual. By virtue of the TCP/IP-based connection, exchanges of messages may be enabled between consumers, vendors, offerors, and the administrator via their respective Web servers. Such messages may include, for example, registration information supplied by a consumer; product information supplied by a vendor; Web site information supplied by an offeror; acceptance, payment, and delivery forms; and similar data, as is more fully described hereinafter. It is to be understood that the term “messages” is intended to encompass all manner of written or graphical information, such as, for instance, plaintext, windows, icons, banners, e-mails, applets, plug-ins, cookies, programs, scripts (e.g., Java scripts), downloadable files, blank forms that can be filled in or completed by the viewer, and the like.

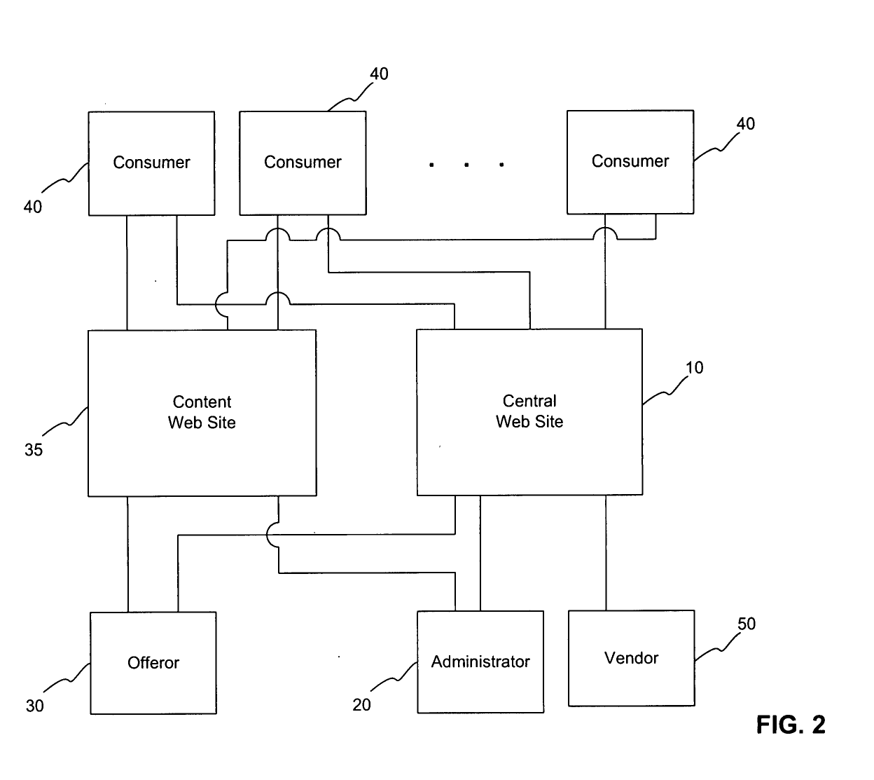

FIG. 2 depicts an exemplary arrangement for interaction between an administrator 20, an offeror 30, a plurality of consumers 40, and a vendor 50. Although FIG. 2 depicts only a single offeror 30 and a single vendor 50, it will be appreciated that any number of offerors 30 and vendors 50 may interact in accordance with the methods of the present disclosure. As discussed above, an offeror 30 may operate a content Web site 35 via an offeror interface 300. Content Web site 35 may be any type of Web site accessed by a plurality of consumers 40. For example, content Web site 35 may be a news site, weather site, Web log (“blog”) site, search engine site, information site, database site, archive site, directory site, download site, video site, music site, entertainment site, encyclopedia site, organizational site, or any other type of Web site of interest to a group of individuals. Consumers 40 may visit content Web site 35 for the purpose of reading, viewing, and/or hearing any type of content information. Content Web site 35 may also be configured to allow interaction with consumers 40. In some cases, consumers 40 may visit content Web site 35 with an intention of conducting a commercial transaction over the site; however, consumers 40 may also visit content Web site 35 with no intention of conducting a commercial transaction.

Offeror 30 may own or co-own the content Web site 35. Alternatively, offeror 30 may be an agent of an owner of the content Web site 35. Offeror 30 may operate, or otherwise control, the appearance of the content Web site 35. Accordingly, offeror 30 may be any entity having an ability to make product offers over the content Web site 35, as described above.

An administrator 20 may provide and operate a central Web site 10. Administrator 20 may be any individual, company, or other entity desiring to provide an online marketplace for uniting the providers of goods and services (i.e., vendors) with owners of content Web sites 35. In some cases, administrator 20 may also be authorized by offeror 30 to operate, or otherwise control, the appearance of the content Web site 35. Therefore, administrator 20 may similarly be able to initiate product offers over the content Web site 35, via the authority of offeror 30. Administrator 20 may make the central Web site 10 available to a plurality of offerors, such as offeror 30, as well as a plurality of vendors, such as vendor 50. For example, administrator 20 may provide a registration process by which offerors 30 and vendors 50 may provide information in exchange for a username and password. Alternatively, administrator 20 may provide an open central Web site 10 on which offerors 30 and vendors 50 may openly post information regarding their Web sites and products, respectively.

In one embodiment, an offeror 30 and a vendor 50 may register with the administrator 20 via the central Web site 10. The offeror 30 may then be configured to provide information regarding a content Web site 35 that it operates via the central Web site 10. Likewise, the vendor 50 may then be configured to provide information regarding one or more products that it is interested in providing to an offeror 30 via the central Web site 10.

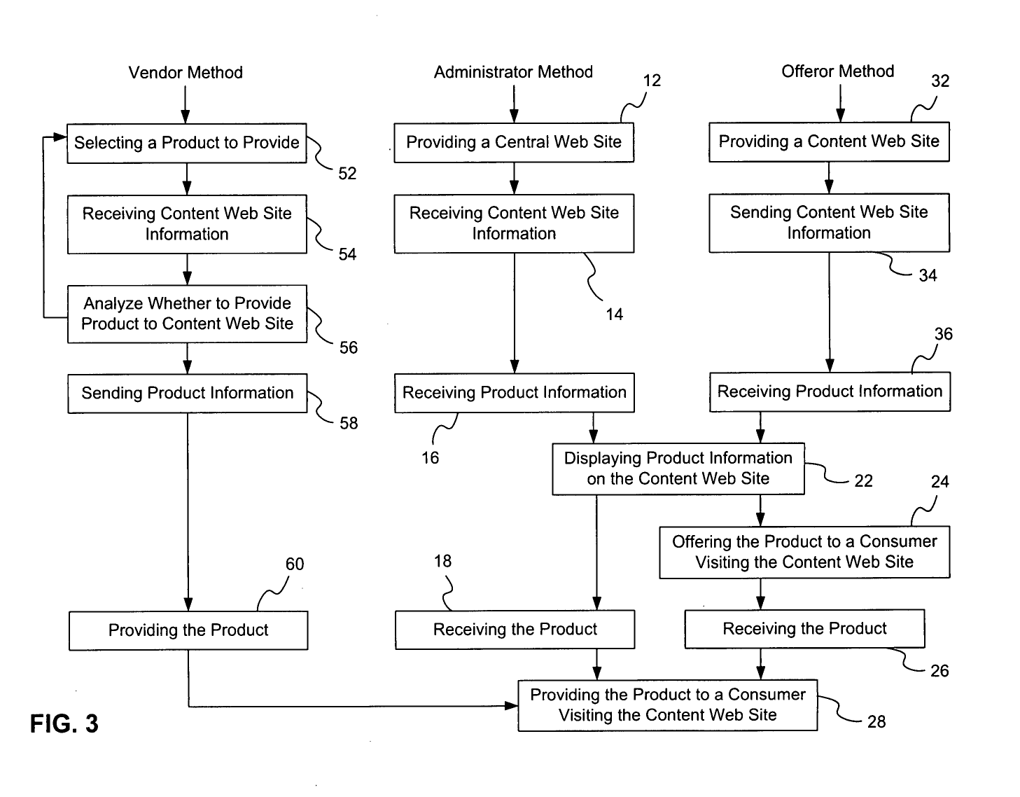

An administrator 20, an offeror 30, and a vendor 50 may therefore be configured to communicate, exchange information, and enter into agreements over the central Web site 10, as will be described more fully with respect to FIG. 3.

FIG. 3 depicts a flow chart of an exemplary method of interaction between a vendor, an administrator, and an offeror. In some cases, a vendor may acknowledge a desire to obtain increased exposure and targeted advertising for one or more products. Such a vendor may take steps to provide such a product to an agent of a content Web site having consumer traffic relevant to the market of the particular product. Meanwhile, an owner of a content Web site (i.e., the offeror) may acknowledge a desire to improve Web site traffic by conducting, for example, a Happy Minute® sweepstakes, as described. Such an offeror may also desire to generate product offers via the Happy Minute® sweepstakes, without absorbing the costs typically associated with purchasing products to offer in the sweepstakes. Accordingly, both such a vendor and such an offeror may associate with an administrator, as described in FIG. 3.

Initially, an administrator may provide a central Web site (step 12). Additionally, an offeror may provide a content Web site on which it desires to increase site traffic (step 32). The offeror may desire to increase content Web site traffic for the purposes of increasing advertising revenue and/or increasing sales of its own products. A vendor may select a product to be distributed by an offeror, for the purposes of increasing product exposure and targeted advertising (step 52).

At any time, the offeror may send information regarding its content Web site to the administrator and/or any vendor (step 34). Information regarding the content Web site may include, for example, visitor demographic information, usage information, content information, and/or advertising information. In one embodiment, the administrator may receive the content Web site information via the central Web site (step 14). Additionally, the vendor may receive the content Web site information from the administrator via the central Web site (step 54). Alternatively, the vendor may receive the content Web site information directly from the offeror, such as through an electronic message or other communication means.

Based on the received content Web site information, the vendor may analyze whether to provide the selected product to the offeror to be offered to consumers on the content Web site (step 56). For example, the vendor may take into consideration the likely interest that visitors to the content Web site may have in receiving the offered product. For this purpose, the vendor may consider information provided by the offeror (e.g., demographics, traffic data, etc.) in relation to the known market for the product. In some cases, the vendor may return to the step of selecting a product (step 52), in order to find a more ideal product to provide for offering on the content Web site. While not illustrated in FIG. 3, it will be appreciated that the vendor may receive content Web site information from any number of offerors. For example, the central Web site may have information from numerous different content Web sites desiring to receive promotional products from various vendors at no cost.

Once a vendor has determined that it would be desirable to market a product via a particular content Web site, the vendor may send information regarding the product to the administrator and/or the offeror corresponding to the particular content Web site (step 58). Information regarding the one or more products may include, for example, a brand, a model number, a name, a product identification code, a production cost, a suggested retail price, a number of available units, a performance specification, a size, a weight, and/or a photograph. In one embodiment, the administrator may receive the product information via the central Web site (step 16). Additionally, the offeror may receive the product information from the administrator via the central Web site (step 36). Alternatively, the offeror may receive the product information directly from the vendor, such as through an electronic message or other communication means.

Once the administrator and/or offeror has received the product information, the administrator and/or offeror may display the product information on the offeror's content Web site (step 22). In one embodiment, this step may occur based on a “product display and offer proposal” generated by the administrator. Alternatively, the product display and offer proposal may be negotiated by the offeror and the vendor. The product display and offer proposal may include the terms and parameters defining how the vendor's product will be displayed and offered on the offeror's content Web site. In one embodiment, the product display and offer proposal may include a time during which the product is displayed, a frequency with which the product is displayed, an amount of information displayed about the product, and/or a portion of the content Web site on which the product is displayed. The proposal may also include a price and delivery charge associated with the product offer. In some embodiments, the product may be merely displayed on a portion of the content Web site which is unused advertising space.

In one embodiment, the display of the product may be a preliminary step to offering the product to consumers visiting the content Web site (i.e., merely an advertisement). In another embodiment, the display of the product may be part of an actual product offer to consumers visiting the content Web site. In certain embodiments, either the administrator and/or the offeror may offer the product to consumers visiting the content Web site (step 24). In a preferred embodiment, the product offer may be made in a manner consistent with the Happy Minute® embodiments described herein. Specifically, the product may be displayed and/or offered on a content Web site for a transient period of time that is unpredictable by consumers visiting the site. As a result, the offeror's content Web site may experience increased “clicks,” increased “stickiness,” and/or increased advertising revenue.

In order to fulfill a product offer accepted by a consumer, the vendor may provide the product to the administrator, offeror, and/or consumer (step 60). In one embodiment, the administrator may receive the product from the vendor for providing to the consumer (step 18). Alternatively, the offeror may receive the product from the vendor or administrator for providing to the consumer (step 26). In yet another embodiment, the vendor may send the product directly to the consumer, as instructed by the administrator and/or offeror. Accordingly, the vendor, administrator, and/or offeror may take part in providing the product to a consumer who has accepted the product offer or otherwise responded to the product information on the content Web site (step 28).

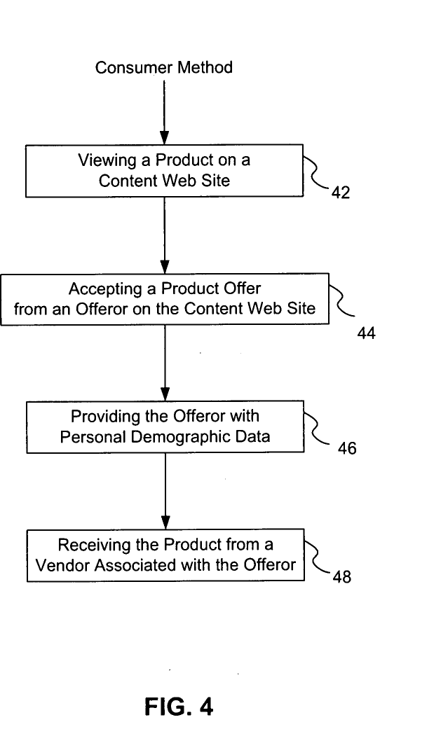

FIG. 4 is a flow chart of an exemplary method for obtaining a product from a vendor, at a cost substantially below its retail price, from the perspective of a consumer who is visiting a content Web site operated by an offeror. The steps of FIG. 4, as with the other methods disclosed herein, may be implemented in any order and, thus, embodiments of the invention are not limited to the sequence of steps illustrated in the drawings.

As shown in FIG. 4, a consumer may visit a content Web site and view a product displayed on the site (step 42). In one embodiment, the consumer may view and accept an offer related to the displayed product (step 44). The consumer may provide the offeror, or an agent of the content Web site, with personal information, such as personal demographic data (step 46). By way of example, the consumer may provide such personal information either before or after accepting the offer, in exchange for receiving the product. Such information may be provided by having the consumer complete a survey or set of questions either on-line through the content Web site, orally by phone, or manually through standard mail. Finally, the consumer may receive the product from a vendor, or an agent of the vendor, associated with the offeror (step 48).

Consistent with FIG. 4 and other embodiments of the present invention, consumers may accept Happy Minute® product offers. Exemplary interfaces and other hardware associated with performing the above-described methods will now be described.

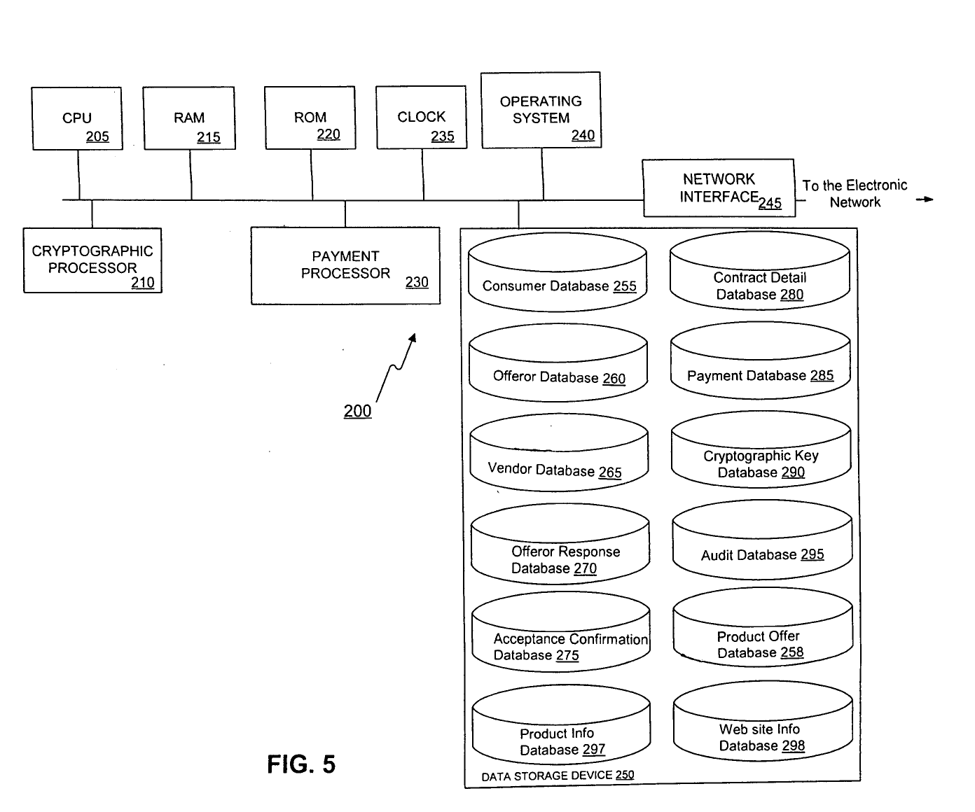

As shown in FIG. 5, administrator interface 200 may include a central processing unit (CPU) 205, a cryptographic processor 210 (e.g., alternatively referred to as an encryption processor), a RAM 215, a ROM 220, a payment processor 230, a clock 235, an operating system 240, a network interface 245, and a data storage device 250. A conventional personal computer, computer workstation, and/or server with sufficient memory and processing capability may be used to implement the various components of administrator interface 200. In accordance with one embodiment of the invention, administrator interface 200 may operate as a Web server or host of the central Web site incorporating the features of the invention, both transmitting product offers generated by the offeror and receiving acceptance forms completed by each consumer. Administrator interface 200 must be capable of reasonable speed for high-volume transaction processing, and for performing a significant number of mathematical calculations in processing communications and database storage. Any suitable type of processor, microprocessor, or combination of microprocessors may be used for CPU 205 and/or cryptographic processor 210. For example, cryptographic processor 210 may use a 16-bit multiply-and-accumulate instruction in the 16 MHz configuration that requires less than one second to perform a 512-bit RSA private key operation. Equivalent microprocessors or more powerful microprocessors may also be used. Cryptographic processor 210 may support the authentication of communications between vendors, offerors, consumers, and the administrator.

Referring again to FIG. 5, payment processor 230 may comprise one or more conventional microprocessors, such as an Intel Pentium processor, supporting the transfer and exchange of payments, charges, or debits attendant to the features of the invention. Payment processor 230 may also be configured as part of CPU 205. Processing of, for example, credit card transactions by payment processor 230 may be supported with commercially available software, such as the Secure Web server manufactured by Open Market Inc. This server software may transmit credit card numbers electronically over the Internet to servers located at the Open Market headquarters where card verification and processing are handled. Services may include online account statements, order-taking, credit card payment authorization, credit card settlement, automated sales tax calculations, digital receipt generation, account-based purchase tracking, and payment aggregation for low-priced goods or services. Other types of credit card transaction processing systems, services, software, and/or networks may also be used in conjunction with the present invention.

Referring to FIG. 5, administrator interface 200 may be connected to a data storage device 250, which may include magnetic and/or optical storage units, as well as flash memory. Data storage device 250 may contain databases used in the processing of transactions in the present invention, including a consumer database 255, an offeror database 260, a vendor database 265, an offeror response database 270, an acceptance confirmation database 275, a contract detail database 280, a payment database 285, a cryptographic key database 290, an audit database 295, a product offer database 258, a product information database 297, and a Web site information database 298.

Consumer database 255 may maintain data on consumers by providing a number of fields, such as name, address, credit card number, phone number, ID number, social security number, electronic mail address, credit history, past system usage, public/private key information, etc. This information may be obtained from consumers when they first register with the system or when they accept offers generated by the administrator or an offeror. Consumer database 255 may also store any type of consumer behavior tracking information, such as the particular sites they have visited, the nature and amount of any purchases they have made, personal preferences, and additional demographic-type data. Consumer database 255 may also contain the tracking number of each acceptance form filled out by the consumer, and the tracking number for the product offer. Consumer database 255 may also be used to enable recognition of the fact that one or more particular individuals is currently browsing a Web site that is part of the network of associated sites. Consumer database 255 may also contain account information for each consumer, including dollar amounts credited and debited for products, delivery costs, and other expenses and payments. For example, consumer database 255 may track all information pertaining to the consumer's account with fields, such as consumer's name, bank and credit account numbers, and debit transactions. In a one embodiment, database software, such as Oracle7 or higher, manufactured by Oracle Corporation, may be used to create and manage these databases. Using the above-noted components, the present invention provides a method and apparatus to transmit a product offer available to all potential consumers who are connected to a member site forming a network of associated Web sites adopting the features of the invention, and allow each such consumer to accept the offer to form a legally binding contract with the offeror.

Offeror database 260 may maintain data on offerors with fields, such as name, contact information, public/private key information, payment preferences, type of business, and goods or services sold. Contact information may comprise a phone number, Web page URL, bulletin board address, pager number, telephone number, electronic mail address, voice mail address, facsimile number, or any other way to contact the offeror. Offeror database 260 may also track all information pertaining to the offeror's account with fields, such as offeror's name, bank and credit account numbers, and debit or credit transactions. Consumer payments for a product offer may also be sent to this account database.

Vendor database 265 may maintain data on vendors with fields, such as name, contact information, public/private key information, payment preferences, type of business, and goods or services sold. Contact information may comprise a phone number, Web page URL, bulletin board address, pager number, telephone number, electronic mail address, voice mail address, facsimile number, or any other way to contact the vendor. Vendor database 265 may also track all information pertaining to the vendor's account with fields, such as the vendor's name, bank and credit account numbers, and debit or credit transactions. Moreover, vendor database 265 may track vendor payments and vendor revenues over time. For example, vendor database 265 may track product information and vendor transaction history, including the product cost, product retail price, vendor profit per product, and reliability of vendor fulfillment of product offers.

Offeror response database 270 may track all product offers and/or offeror responses with various fields, such as offeror name, offeror ID number, date, time, offeror response tracking number, and associated sales offer tracking number. Acceptance confirmation database 275 may track messages sent between the consumer and offeror confirming completed transactions (bound contracts). Fields may include consumer name, consumer ID number, offeror name, offeror ID number, purchase confirmation tracking number, and associated product offer tracking number.

Contract detail database 280 may track any details regarding contracts formed between vendors, offerors, and consumers. For example, contract detail database 280 may track product display and offer proposals generated by the administrator.

Payment database 285 may track all payments made by consumers by means of fields, such as consumer name, consumer ID number, amount of payment, and associated product offer tracking number. This database may also store credit card numbers of consumers. Payment database 285 may also track all payments made and/or received by vendors and offerors, including information such as the respective vendor/offeror name, ID number, amount of payment, and associated product offer tracking number.

Cryptographic key database 290 may facilitate encryption or cryptographic functions, storing both symmetric and asymmetric keys. These keys may be used by cryptographic processor 210 for encrypting and decrypting consumer credit card numbers and dates of expiration.

Audit database 295 may store transactional information relating to the transmission of each product offer, allowing it to be retrieved for later analysis.

Product offer database 258 may track all product offer fields, such as status, tracking number, date, time, article, price, expiration date, conditions, and consumer identification number. This database may be valuable in the event of disputes between consumers and offerors regarding payment, because details of the contract can be produced from contract detail database 280. Product offer database 258 may also store bond certificate and other related information.

Product information database 297 may contain information about products offered by various vendors. Specifically, product information database 297 may store any information received from a vendor, regarding a product made available for a product offer. Accordingly, product information database 297 may be configured to store product information for use by an offeror. For example, product information database 297 may include a brand, a model number, a name, a product identification code, a production cost, a suggested retail price, a number of available units, a performance specification, a size, a weight, and a photograph.

Web site information database 298 may contain information about each content Web site associated with each participating offeror. Specifically, Web site information database 298 may store any information received from an offeror, regarding a content Web site on which increased traffic is desired. Thus, Web site information database 298 may be configured to provide such information for use by interested vendors. Web site information database 298 may include any type of consumer behavior tracking history for each content Web site associated with a particular offeror. For example, Web site information database 298 may contain information regarding visitor demographic information, individual consumer purchase histories, usage information, Web site content information, and advertising information.

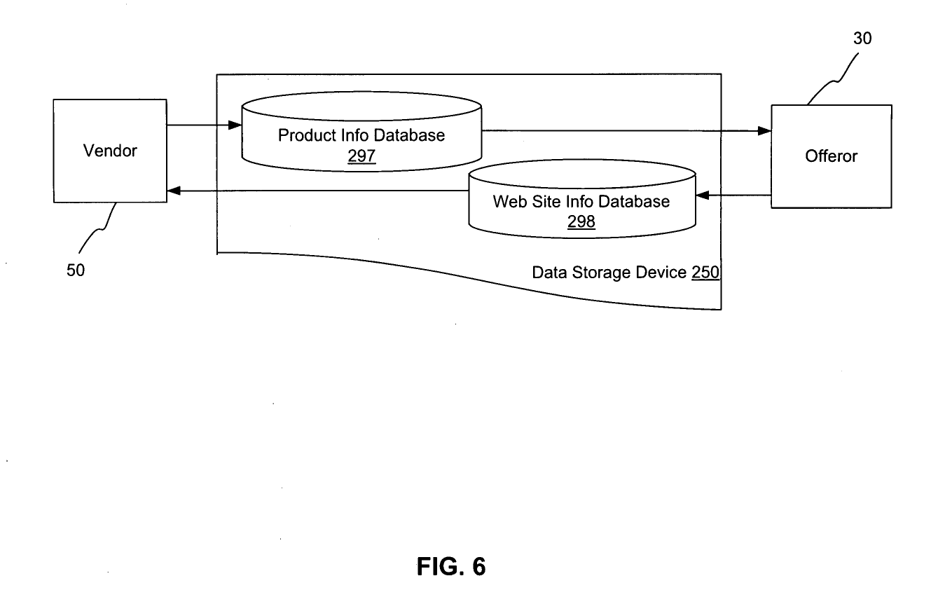

As shown in FIG. 6, product information database 297 and Web site information database 298 may be particularly relevant to certain embodiments of the invention in which one or more vendors 50 propagate information to/from product information database 297 and one or more offerors 30 propagate information to/from Web site information database 298. Specifically, offerors 30 and vendors 50 may be configured to communicate with these databases within data storage device 250, via offeror interfaces 300 and vendor interfaces 500, respectively.

Referring again to FIG. 5, network interface 245 may be a gateway to permit administrator interface 200 to communicate with offerors via offeror interfaces 300, consumers via consumer interfaces 400, and vendors via vendor interfaces 500. Conventional internal or external modems may serve as network interface 245. Network interface 245 may support modems at any range of baud rates from 1200 upward, but may combine such inputs into a T1 or T3 line if more bandwidth is required. In a preferred embodiment, network interface 245 may be connected with the Internet and/or any commercial online service, allowing consumers, offerors, and vendors to have access from a wide range of online connections. Several commercial electronic mail servers may also include the above functionality. Network interface 245 may also be configured as a voice mail interface, Web site interface, BBS, or electronic mail address.

While the above embodiment describes a single platform acting as administrator interface 200, those skilled in the art will realize that the functionality can be distributed over a plurality of computers or platforms. In one embodiment, administrator interface 200 may be configured in a distributed architecture, wherein the databases and processors are housed in separate units or locations. Some controllers may perform the primary processing functions and contain at a minimum RAM, ROM, and a general processor. Each of these controllers may be attached to a WAN hub, which serves as the primary communication link with the other controllers and interface devices. The WAN hub may have minimal processing capability itself, serving primarily as a communications router. Those skilled in the art will appreciate that an almost unlimited number of controllers may be supported. This arrangement may yield a more dynamic and flexible system, less prone to catastrophic hardware failures affecting the entire system. Such a trusted server embodiment may provide a distributed environment, including a server, a trusted server, and a bonding agency. The hardware of these servers would be configured similarly to that described for administrator interface 200.

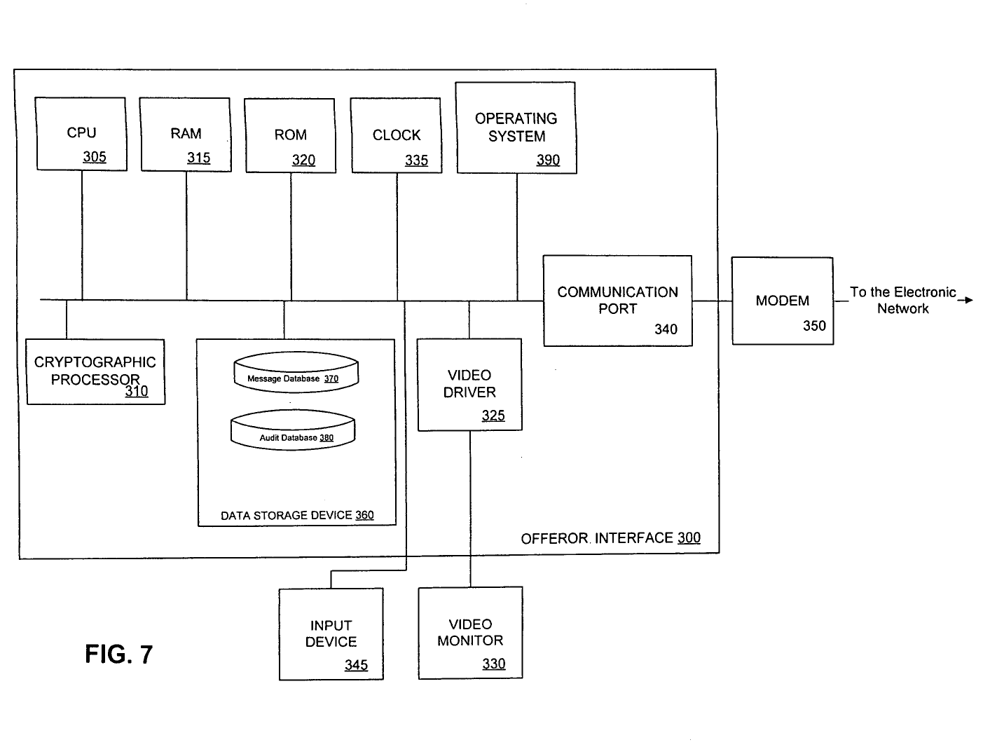

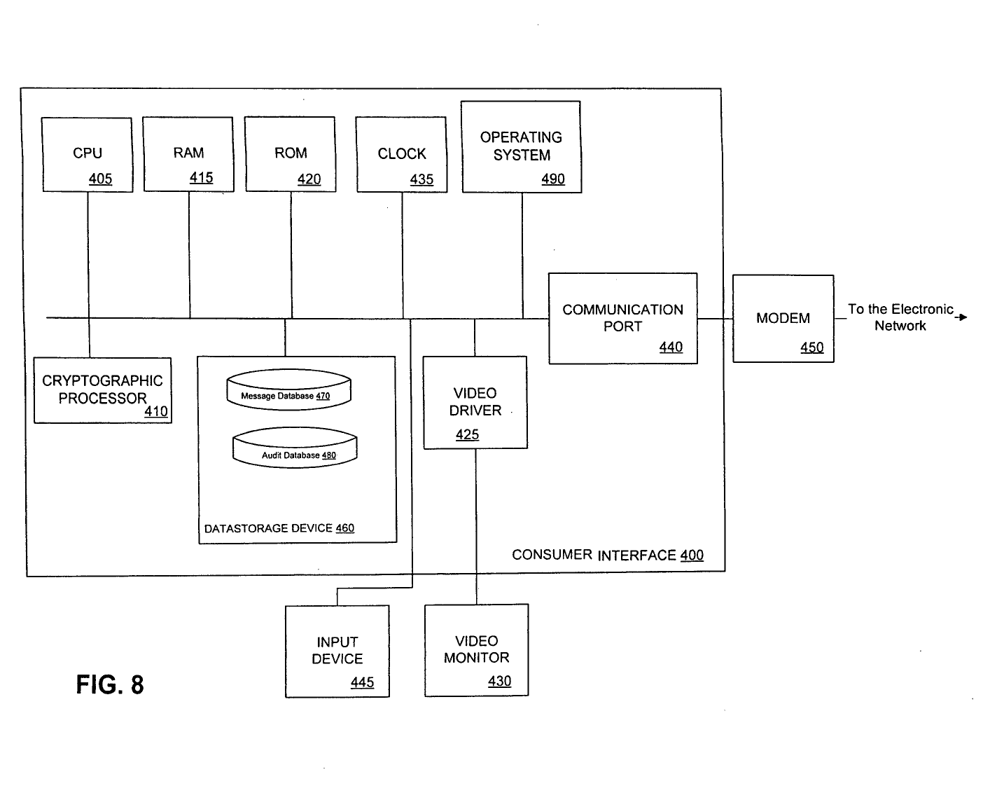

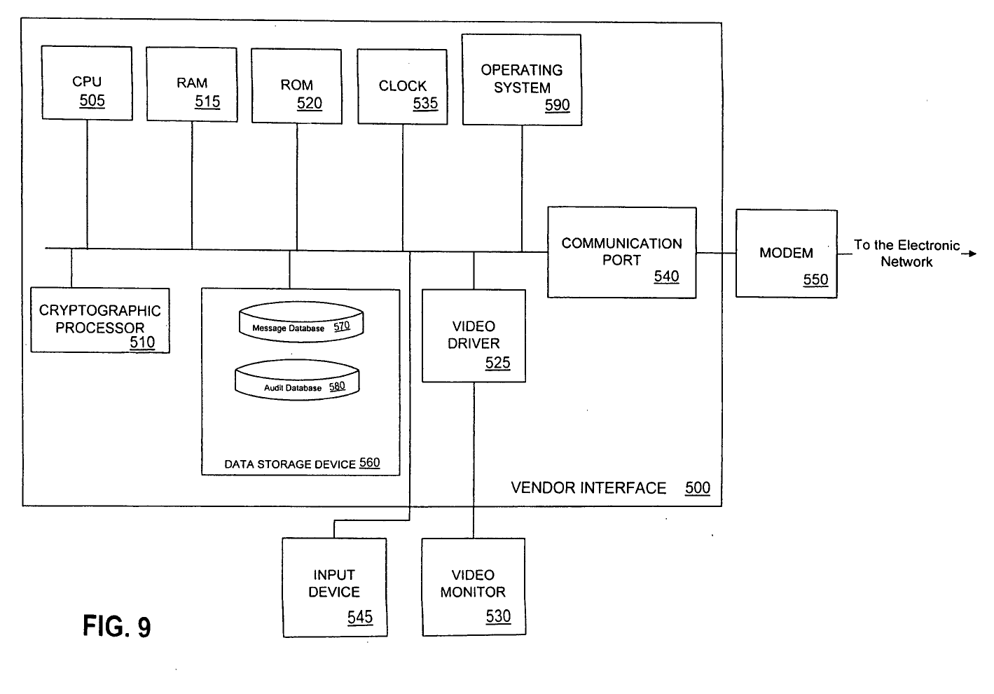

FIG. 7 illustrates the features of an exemplary offeror interface 300, FIG. 8 illustrates the features of an exemplary consumer interface 400, and FIG. 9 illustrates the features of an exemplary vendor interface 500. In an exemplary embodiment, offeror interface 300, consumer interface 400, and vendor interface 500 may be conventional personal computers having an input device, such as a keyboard, mouse, or conventional voice recognition software package; a display device, such as a video monitor; a processing device, such as a CPU; and a network interface, such as a modem. These devices may interface with administrator interface 200, either directly or through a network environment (such as the Internet).

As shown in FIG. 7, offeror interface 300 may include a central processing unit (CPU) 305, a cryptographic processor 310, a RAM 315, a ROM 320, a clock 335, a video driver 325, a video monitor 330, a communication port 340, an operating system 390, an input device 345, a modem 350, and a data storage device 360. In one embodiment, a Pentium microprocessor may be used for CPU 305. Clock 335 may be a standard chip-based clock, which can serve to time-stamp an offeror response or communication produced by offeror interface 300. As further shown in FIG. 3, data storage device 360 may include a message database 370 and an audit database 380, and may be configured with a conventional magnetic-based hard disk storage unit, such as those manufactured by Conner Peripherals. Message database 370 may be used for archiving offeror Web site information responses or other offeror communications, while audit database 380 may be used for recording payment records and communications with administrator interface 200, consumer interfaces 400, and/or vendor interfaces 500.

As shown in FIG. 8, consumer interface 400 may include a central processing unit (CPU) 405, a cryptographic processor 410, a RAM 415, a ROM 420, a clock 435, a video driver 425, a video monitor 430, a communication port 440, an operating system 490, an input device 445, a modem 450, and a data storage device 460. In one embodiment, an Intel Pentium or higher microprocessor may be used for CPU 405. Clock 435 may be a standard chip-based clock, which can serve to time-stamp a consumer response or communication produced with consumer interface 400. Data storage device 460 may include a message database 470 and an audit database 480, and may be configured with a conventional magnetic-based hard disk storage unit, such as those manufactured by Conner Peripherals. Message database 470 may be used for archiving consumer acceptance messages or other consumer communications, and audit database 480 may be used for recording payment records and communication with administrator interface 200, offeror interfaces 300, and/or vendor interfaces 500.

As shown in FIG. 9, vendor interface 500 may include a central processing unit (CPU) 505, a cryptographic processor 510, a RAM 515, a ROM 520, a clock 535, a video driver 525, a video monitor 530, a communication port 540, an operating system 590, an input device 545, a modem 550, and a data storage device 560. In one embodiment, a Pentium microprocessor may be used for CPU 505. Clock 535 may be a standard chip-based clock, which can serve to time-stamp a communication produced with vendor interface 500. Data storage device 560 may include a message database 570 and an audit database 580, and may be configured with a conventional magnetic-based hard disk storage unit, such as those manufactured by Conner Peripherals. Message database 570 may be used for archiving vendor product information messages or other vendor communications, and audit database 580 may be used for recording payment records and communication with administrator interface 200, offeror interfaces 300, and/or consumer interfaces 400.

There are many commercial software applications that can enable the communications required by offeror interface 300, consumer interface 400, or vendor interface 500, the primary functionality being message creation and transmission. Eudora Pro manufactured by Qualcomm Incorporated, for example, may provide editing tools for the creation of messages as well as the communications tools for routing a message to the appropriate electronic address. When administrator interface 200 is configured as a Web server, conventional communications software, such as the Microsoft Explorer or Netscape Navigator Web browser, may also be used. For example, the consumer and offeror may use the Netscape Navigator browser or another type of browser to transmit or accept product offers, offeror responses, consumer responses, or counteroffers (if applicable). Moreover, the consumer and offeror may be required to use proprietary software to generate or receive such product offers. Similarly, a vendor and offeror may use any type of Web browser for communicating information regarding products and content Web sites.

In general, communications relating to the product offers may take place via an electronic network, such as the Internet, and the Web sites themselves may act as normal Web sites. In one embodiment, a plug-in installed at each of offeror interfaces 300, consumer interfaces 400, and vendor interfaces 500 may allow the sites to be part of the Happy Minute® Network. Each plug-in may “talk” periodically with the administrator interface 200 to receive lists of the Web sites that form the Happy Minute® Network. During consumer navigation, the plug-in may keep track of the event of going into and out of an associated content Web site and send information of the event to the administrator interface 200. Thus, the administrator interface 200 may be aware about the consumers currently visiting the associated content Web sites. To send a product offer, the administrator interface 200 simply “talks back” to the plug-in to display the acceptance form. Each content Web site may be owned by, or operated for, the benefit of a particular offeror of goods or services. Content Web sites may also be provided that are owned by or operated for the benefit of a third party. In such cases, the content Web site may provide information related to the goods or services of the offeror and/or routinely offer the goods or services of any other vendor. As indicated above, the product offers of the present invention are electronically presented on one or more associated content Web sites for viewing and acceptance by a consumer visiting such site when the product offer is made. The generation of the product offers may be controlled by the administrator interface 200 so that the offers appear at unpredictable times during the day on the Web site. The quantity and type of goods or services that are offered may be set according to communications or instructions received from the offeror. The offeror may also designate the frequency and period of time during which each product offer is presented. Responses from consumers and/or the results of the product offers may be collected by the administrator interface 200 and communicated to the offeror. Communications between the consumer and offeror may also be supported through the electronic network environment of the invention to facilitate the completion of the sale of the goods or services, and/or to permit additional promotions or offers to be communicated from the offeror to the consumer.

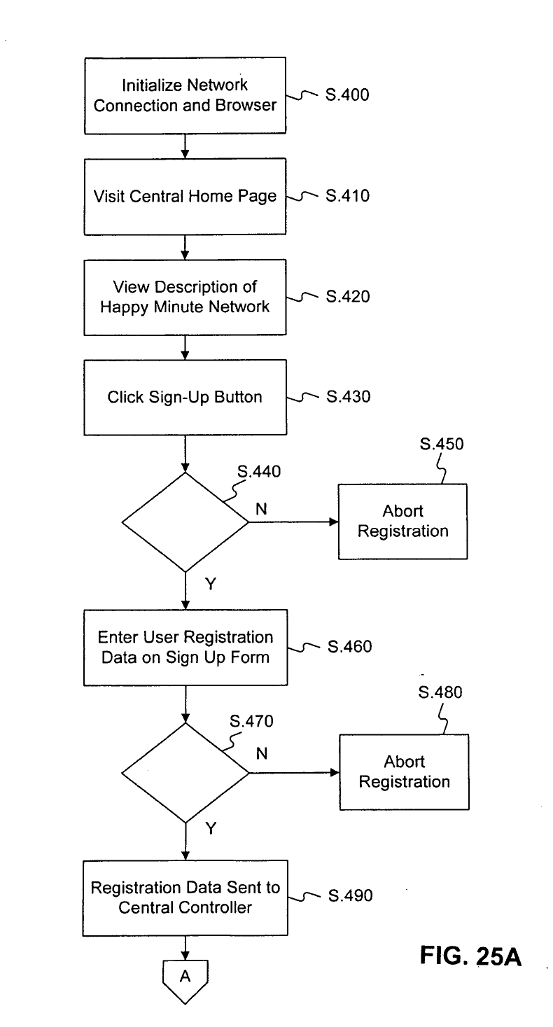

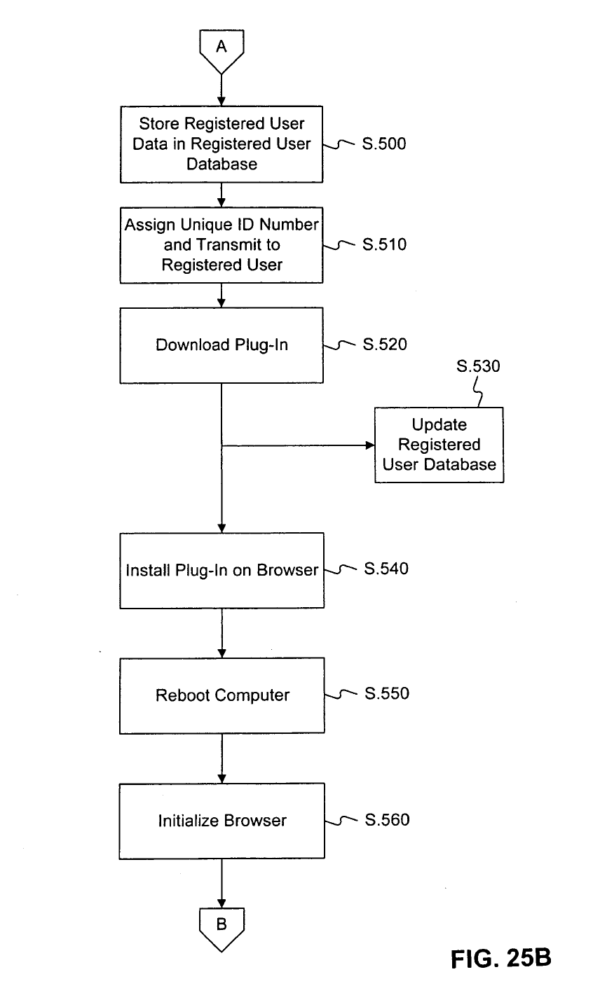

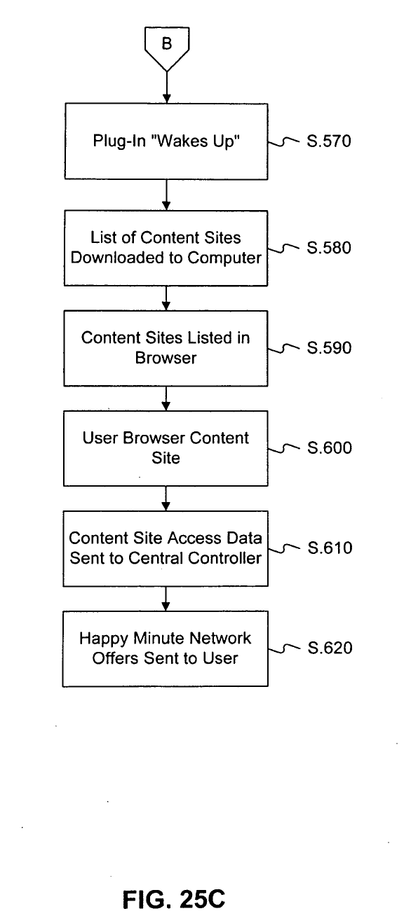

Described next, with reference to FIGS. 25A-C, is an exemplary process for a content Web site visitor to become a registered consumer and eligible to receive product offers while the registered consumer visits member Web sites that are associated with the Happy Minute® Network, or the home page of the Happy Minute® Network administrator itself. It will be appreciated, however, that in some embodiments, it may not be required for a consumer to register with the central Web site in order to receive product offers.

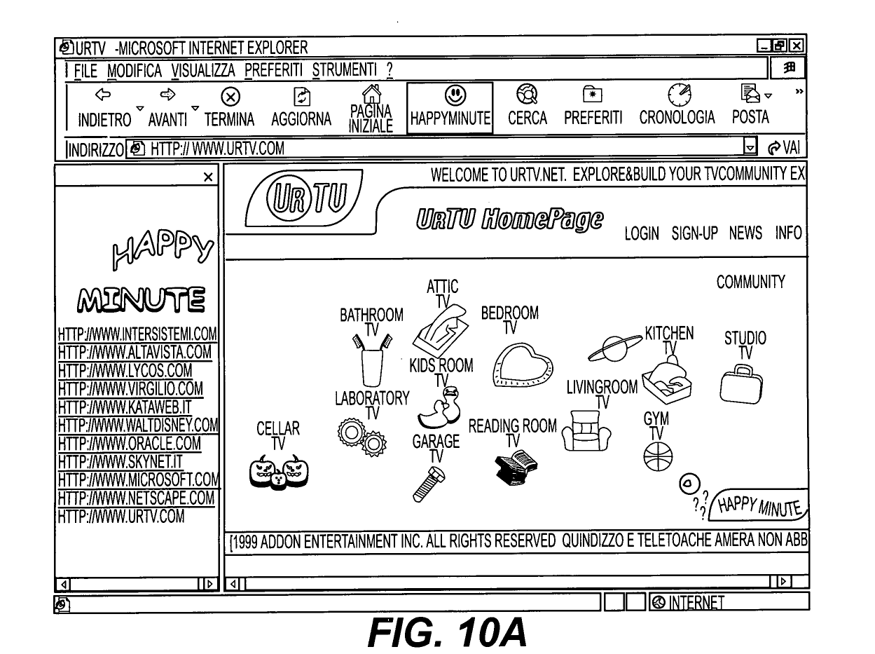

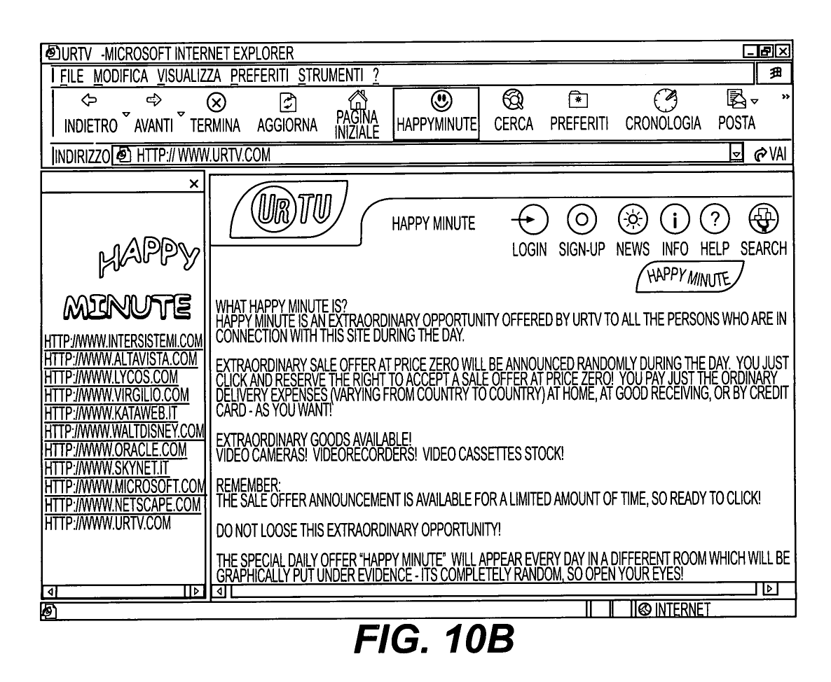

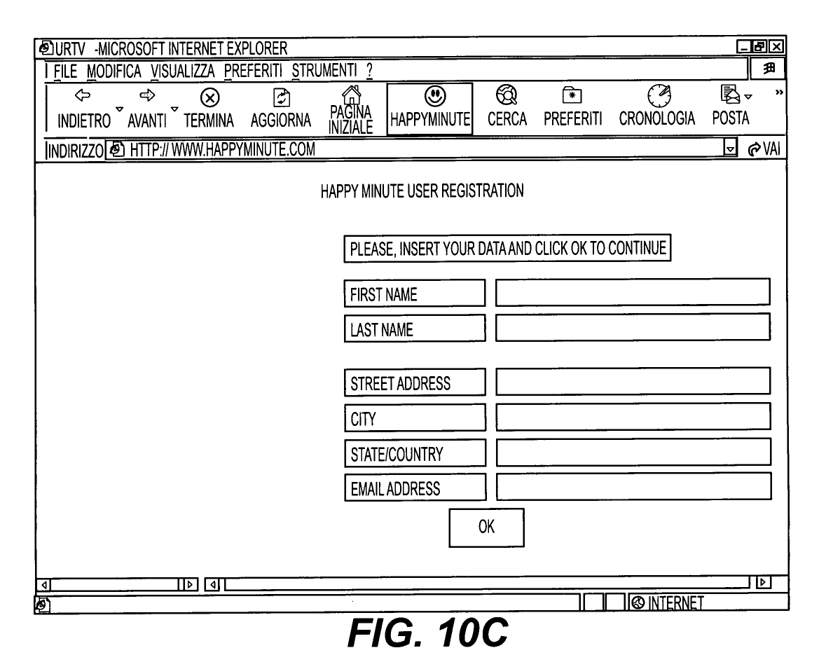

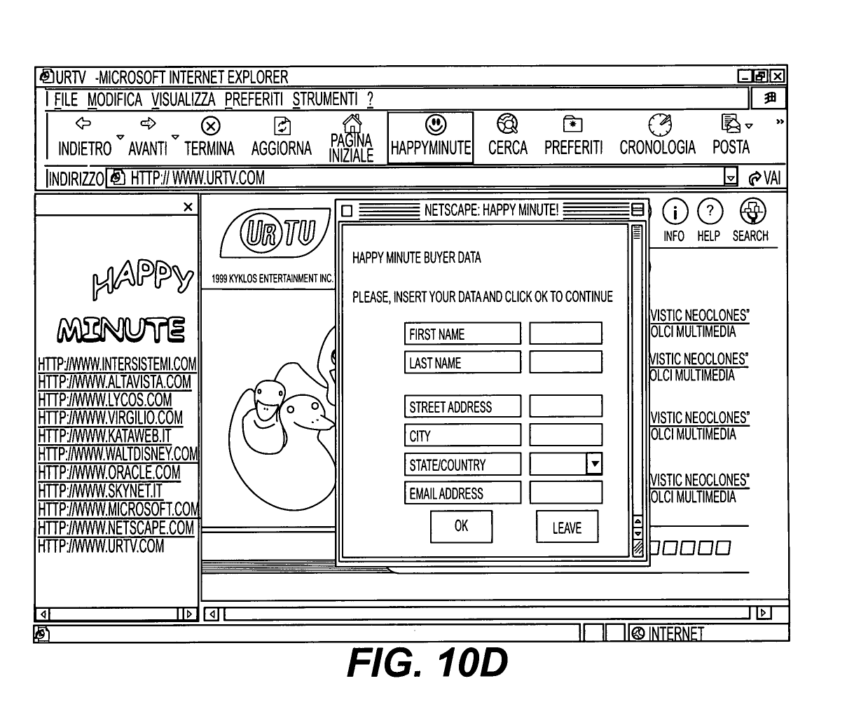

Typically, as shown in FIG. 25A, a consumer will first establish a connection with an Internet Service Provider (ISP) and launch a Web browser (S.400). Next, the consumer will either “surf” the Internet, or select a bookmarked or favorite home page to browse. Upon visiting the Happy Minute® Network administrator home page, or a Web page of a Happy Minute® Network member (i.e., an associated Happy Minute® Network Web site) (S.410), an introductory or explanatory Web page describing the Happy Minute® Network concept and features, such as shown in FIG. 10A, will be presented (S.420). If the visitor is interested in participating, he or she may click on the “sign-up” icon or button, which will result in a registration window or frame popping up, an example of which is depicted in FIG. 10B (S.430). The viewer may click the “Leave” button in the registration window (S.440), in which case the registration process is aborted (S.450). The registration window includes a form with a number of fields that may be completed by the registrant (S.460). These include the registrant's first and last name, street address, city, state/country, and e-mail address. Other appropriate registrant-related data may also be requested by providing additional fields in the registration form. Once the visitor has provided the requested data (S.460), an “OK” button may be clicked (S.470), which permits all of the collected data to be transmitted to the administrator interface 200 (S.490) and stored in the consumer database 255 of data storage device 250 (S.500—FIG. 25B). After completing the registration process, each registered consumer may be assigned a unique personal ID number, which may also stored in consumer database 255 and which is transmitted to the consumer as confirmation that he or she has been duly registered (S.510). Alternatively, a visitor may entirely abort the registration process by clicking a “leave” button, which is also provided on the registration frame or window (S.480).

The registration process may additionally include the furnishing of a plug-in to the registered consumer's computer system. As shown in FIG. 25B, after being supplied with a personal ID number (S.510), the Happy Minute® Network central Web site may automatically download the plug-in (S.520) and install the same in a predefined system directory (S.540). The consumer may then be able to monitor the progress of the download through a “Saving Location” window, which typically shows a progress bar. The progress window may disappear once the download is complete. The downloaded file may be an executable program that is run by the consumer by opening or running the program, which may then install the plug-in to thereby become part of the Web browser functionality (S.540). Meanwhile, the central Web site may note the consumer having proceeded with the plug-in download step and records this in the consumer database 255 as part of that consumer's profile (S.530). Certain browsers and operating systems may require a system reboot before a plug-in will be recognized (S.550). After any necessary reboot, the consumer may launch the browser (S.560).

A plug-in may be a software module designed to work in cooperation with an Internet browser or other means to access associated Web sites (also referred to as “content sites”) connected to the electronic network (e.g., BBS, Wireless Application Protocol (WAP) servers). When the browser starts, the plug-in may automatically wake up and initialize itself, giving information to the consumer, and opening, for example, a frame or window on a visible area of the screen (S.570—FIG. 25C). After such a wake up, the plug-in may automatically connect to the administrator interface 200 and download the list of the content sites belonging to the Happy Minute® Network (S.580). The list of the content sites may then appear in a frame or window in the browser (S.590). While a consumer surfs the Internet, the plug-in may acquire from the browser (or other kind of software used to access the electronic network) information about the content sites being visited (S.600). When a consumer visits a content site belonging to the Happy Minute® Network, a message may be sent to the administrator interface 200 containing the name of the site and the pages the consumer currently is viewing (S.610). The administrator interface 200 may store this information into a consumer tracking database for use during the product offer event (S.620). Whenever a consumer leaves the Happy Minute® Network content site, the plug-in may send another message to the administrator interface 200, so that the tracking database can record the duration of the consumer's visit to each site, as well as be updated to reflect that the consumer is no longer browsing a Happy Minute® Network content site. When consumers gain access to the plug-in frame or window, they can access directly the content sites by clicking on the active links listed in the frame or window.

At this point, when the Happy Minute® Network releases a product offer, it may be sent to the plug-in, having communicated its being on the content Web site upon which the product offer is to be made.

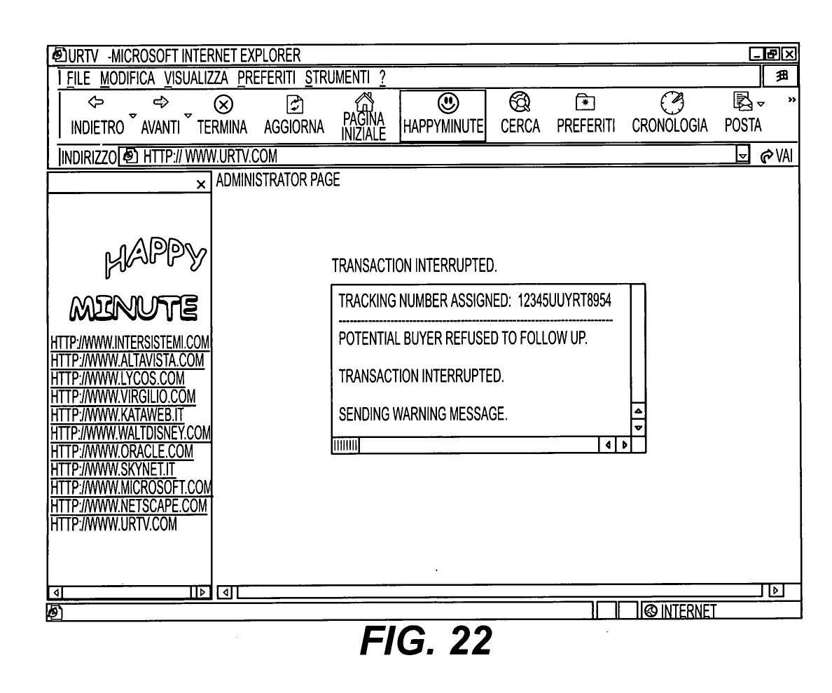

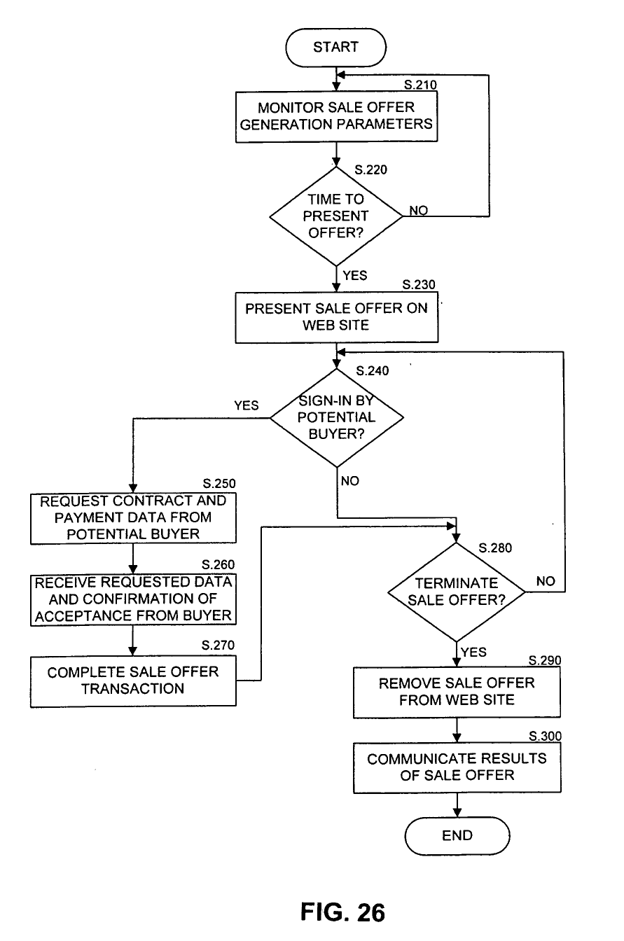

Referring to FIGS. 10A through 24, exemplary graphical consumer interfaces will be described to demonstrate the principles of the invention. Moreover, reference will be made to the exemplary flow charts of FIGS. 26-28 to describe how product offers may be generated, accepted, and completed. Although the embodiments of FIGS. 10A-28 may illustrate the manner in which a product offer may be generated and accepted for particular types of goods, the present invention is not limited to the presentation of the goods shown or to product offers for goods in general. Instead, the invention also relates to product offers for services and may be readily adapted for generating product offers for any type of service offered by an offeror.

FIG. 26 is a flow chart of an exemplary method for generating and accepting product offers, in accordance with an embodiment of the present invention. Generally, as shown in FIG. 26, the process may begin by the administrator interface 200 monitoring the parameters that define when and how the product offer is generated on the content Web site (S.210). As disclosed herein, these parameters may include the frequency and duration during which the product offer is to be presented on the content Web site during a given day. For example, the product offer generation parameters may define the specific time(s) when the product offer is to be presented, or they may simply indicate the number of offers to be presented per day, with the exact time for generating each offer being randomly selected by the administrator interface 200. The product offer generation parameters may also indicate how long each product offer is to be presented on the content Web site and whether to terminate the product offer if a potential consumer does not provide sufficient data or does not confirm acceptance of the product offer within a predetermined time period. The product offer generation parameters may also include the portion of the content Web site on which the product offer is to be displayed. For example, in one embodiment, the product offer may be displayed only on unused advertising space on the content Web site. Other parameters concerning each product offer may also be stored and monitored by the administrator interface 200, including the quantity and/or type of goods to be offered, and the price (if any) and sale terms for the offer.

While monitoring the product offer generation parameters, the administrator interface 200 may determine when it is time to present the product offer on the content Web site (S.220). If the administrator interface 200 determines that it is time to present the product offer (S.220; Yes), then the product offer may be electronically presented on the content Web site according to the parameters (S.230). As indicated above, the time to generate the product offer may be predefined by the product offer generation parameters or randomly triggered by, for example, an internal clock of the administrator interface 200. When it is time to present a product offer, the administrator interface 200 may cause the product offer to be displayed. For example, administrator interface 200 may display the product offer directly on the content Web site or, alternatively, it may instruct offeror interface 300 to display the product offer on the content Web site. If, however, the administrator interface 200 determines that it is not time to present the product offer (S.220; No), then the product offer is not generated and the administrator interface 200 continues to monitor the product offer generation parameters (S.210).

After presenting the product offer on the content Web site (S.220), the administrator interface 200 may monitor which consumers are connected to the content Web site have responded to the product offer and requested to sign in for more information on the offer. In other words, the administrator interface 200 may determine when a potential consumer has decided to sign in for the product offer (S.240). When there is a sign-in by a potential consumer (S.240; Yes), the administrator interface 200 may then request contract and payment data from the potential consumer (S.250). The contract data may include the name and address of the potential consumer. The payment data may include payment terms or instructions, such as credit card information or confirmation of cash payment on delivery. The request for the contract and payment data may be displayed through one or more windows or pop-up screens on the content Web site. These windows or screens may also include more detail concerning the goods or services offered, as well as the specific terms of the product offer. In addition, these windows or screens may request the potential consumer to confirm acceptance of the product offer and, thus, form a legally binding contract with the offeror.

In response to the request from the administrator interface 200, the potential consumer may provide the requested data and confirm acceptance of the product offer through consumer interface 400 to the electronic network environment. The administrator interface 200 may then receive the requested data and confirmation from the consumer (S.260). This information may be stored and/or verified by the administrator interface 200 in order to complete the product offer transaction with the consumer (S.270). For example, the administrator interface 200 may verify that all of the necessary data (such as name, address, etc.) and the confirmation of the acceptance was collected by the consumer. The administrator interface 200 may also verify the payment terms or instructions (such as a valid credit card number) before completing the transaction with the consumer. If all necessary data is verified by the administrator interface 200, then the confirmation may be sent to the consumer with, for example, a tracking or reference number in order to complete the transaction. The administrator interface 200 may also post or issue a purchase and delivery order containing the consumer's data, so that the purchased goods are delivered in a timely fashion by one or more agents.

In the event that the potential consumer does not accept the terms of the product offer or fails to provide the requested data and confirmation to the administrator interface 200, then the sign-in process with the potential consumer may be terminated. For this purpose, the potential consumer may be given the option to leave the sign-in process by entering an appropriate response (e.g., clicking a designated icon or button on the screen). The exemplary process of FIG. 26 may also be modified to permit termination of the sign-in process with the potential consumer if other conditions are present. For example, the sign-in process may be terminated if improper data is entered by the potential consumer or if the data entered by the consumer cannot be verified (such as an unconfirmed credit card number).

Referring again to FIG. 26, the administrator interface 200 may monitor and respond to each potential consumer that has decided to sign in for the product offer (S.240). Since the product offer of the present invention is preferably displayed for only a limited time, the administrator interface 200 may also monitor and determine when to terminate the product offer (S.280). This determination may be performed by the administrator interface 200 based on the stored product offer parameters. A product offer may be terminated or removed from the content Web site when, for example, the defined time duration for the offer has expired. A product offer may also be terminated if the quantity of goods to be offered has been depleted (i.e., all of the inventory of available goods has been purchased by consumers).

If the administrator interface 200 determines that a product offer should be terminated (S.280; Yes), then the product offer may be removed from the plug-in by administrator interface 200 (S.290). During this step, the administrator interface 200 may update the content on the plug-in to replace or redisplay content (such as banner ads or other portions of the plug-in) that was displaced by the product offer. After removing the product offer, the administrator interface 200 may analyze the results of the product offer and communicate the same to the offeror or content Web site owner (S.300). These results may also be communicated to the vendor. These results may indicate, for example, the response level to the product offer and general information about the consumers that responded to the offer.

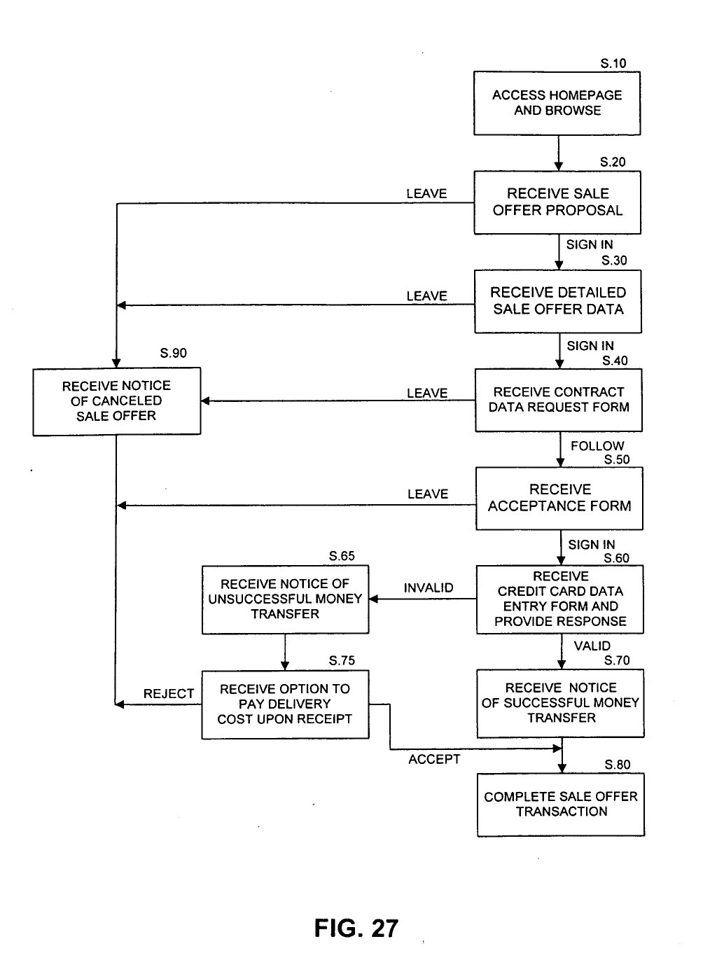

FIG. 27 is a flow chart of an exemplary method that illustrates how a potential consumer may interact with the administrator interface 200 or an offeror to view and accept product offers. In particular, as shown in FIG. 27, potential registered consumers may visit a particular associated content Web site and browse the site. The content Web site may be owned by the offeror or may be owned by a third-party that provides information or regularly offers the goods or services of the offeror. In either case, the content Web site (such as that shown in FIG. 10A) may contain any number of buttons or icons in the form of letters or symbols displayed on the consumer interface 400. Some icons can represent a particular type of room or page that displays a particular category of information. For example, as shown in the embodiment of FIG. 10A, icons, here depicted as “rooms” involving different categories of information may include a Kidsroom TV, a Garage TV, a Kitchen TV, or a Gym TV. Although the illustrated embodiment of FIG. 10A is shown with a finite number of particular content based rooms, any number of different types of rooms may be utilized. Other icons, such as an icon labeled “Happy Minute®,” can be included to provide information about the product offer system. It will be further noted that the Web page shown in FIG. 10A may be divided into two or more frames, as shown here by way of example. The right-hand frame may be an exemplary depiction of the home or main page of the Happy Minute® Network administrator frames, as opened by the plug-in. The left-hand frame may contain a listing of other content Web sites (in Uniform (or Universal) Resource Locator (“URL”) format) that are associated with, and thereby form a portion of, the Happy Minute® Network. A consumer who clicks on the URL of a Happy Minute® Network member, may be taken directly to that member's content Web site, through the well-known feature of “linking” which is enabled in virtually all currently used Web browsers.

In order to find out how the product offer system operates, a potential consumer may simply click on a predetermined icon (such as the “Happy Minute®” or “Info” icon) site, by linking to a Happy Minute® Network member's site, to visit a product offer information page. As illustrated in the embodiment of FIG. 10B, for example, the product offer information page may include general information and describe a number of important aspects of the product offer system. For instance, the product offer information page may indicate that conditional purchase offers (i.e., product offers) can be made at any time and at any location of the Web site. Moreover, the product offer information page may provide important terms of the product offer. In particular, as illustrated in the embodiment of FIG. 10B, a product offer may include an offer to sell a product or service at a price of “zero,” as long as the consumer pays the cost of delivery and/or associated fees. Other purchase price information and/or terms of sale may also be displayed to potential consumers, such as the requirement that the consumer must accept a product offer within a limited period of time. Additionally, the product offer information page may include links or display any other kind of information, such as a visual or audio display of the types of products that will be offered and the number of products that have yet to be offered.

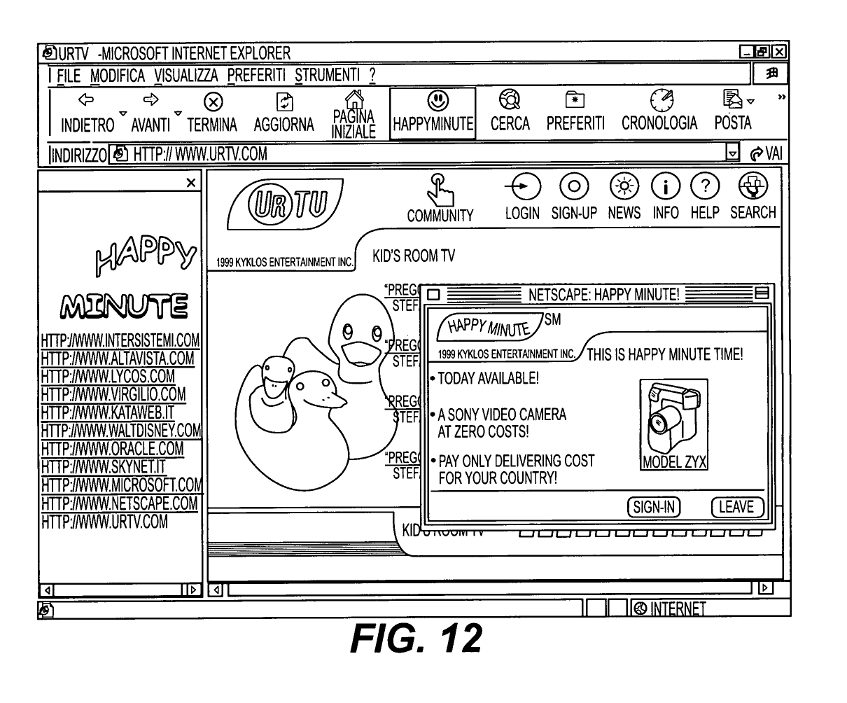

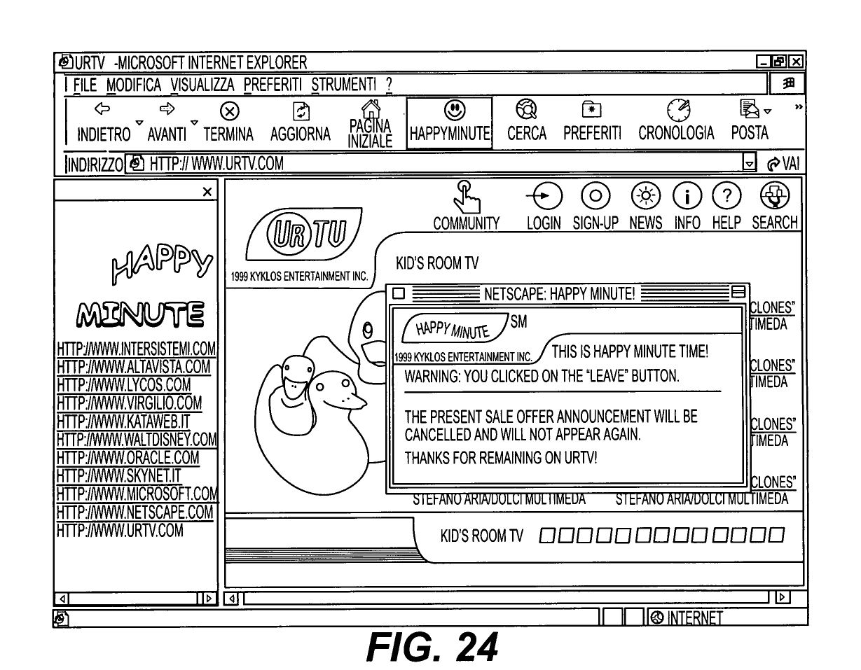

Referring again to FIG. 27, while the consumer is browsing the content Web site of a Happy Minute® Network associate, a product offer may be randomly generated and received by the consumer (S.20). As illustrated in the example of FIG. 12, the product offer may appear as a pop-up window and include basic information concerning the product offer (e.g., the particular product or service being offered, basic terms of the offer, etc.). The pop-up screen containing the product offer may also include icons to permit the consumer to “Sign-in” and accept the offer, or “Leave,” thereby rejecting the offer. If the consumer rejects the offer, then a notice (such as that shown in FIG. 24) may be provided to the consumer to provide notification of the canceled product offer (S.90). Thereafter, the consumer may continue to further browse the content Web site (S.10), go to another content Web site, or terminate the current browser session.

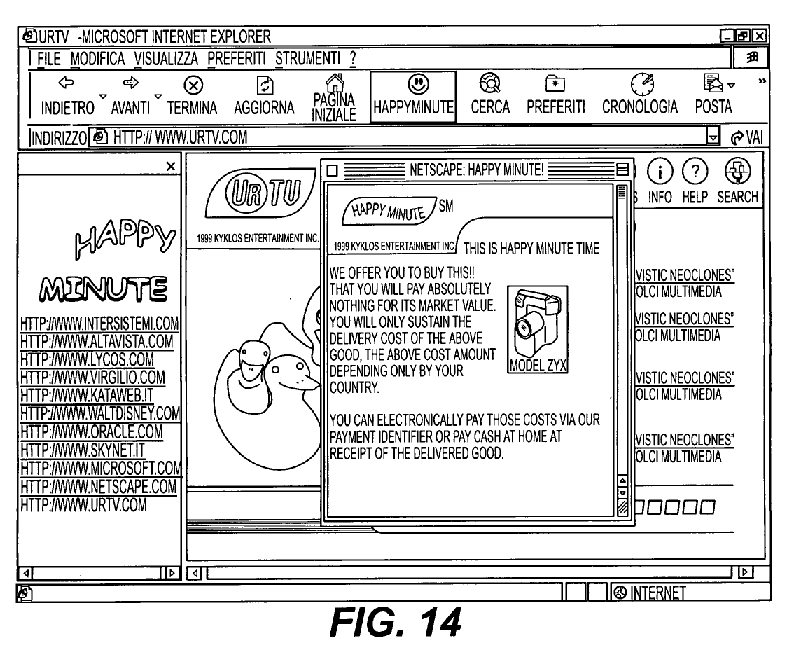

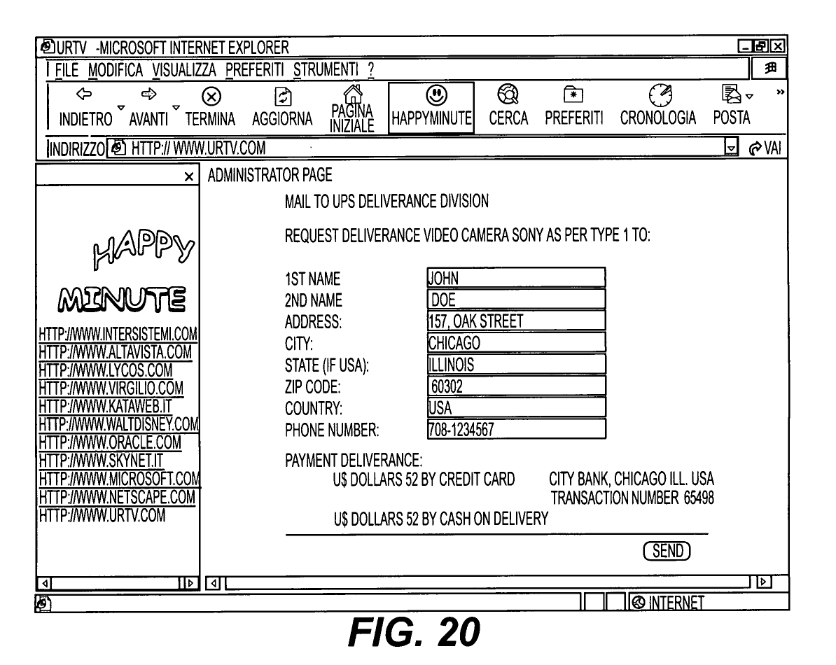

As further shown in FIG. 27, if the consumer decides to accept the offer and sign-in, then another pop-up screen may be provided (such as that shown in FIG. 14) to provide more detailed information concerning the product offer (S.30). After reviewing and further considering the product offer, the consumer may be given another opportunity to accept or reject the product offer. If the consumer rejects the offer, then a notice (such as that shown in FIG. 24) may be provided to give notification of the canceled product offer (S.90). Otherwise, if the consumer decides to continue with the sign-in process, then an electronic request form (such as that shown in FIG. 20) may be displayed to request basic contract data, including the name and address of the consumer (S.40). At this point, the consumer may again be given the opportunity to continue with the sign-in process (S.50) or to reject the offer and receive a notice of the canceled product offer (S.90).

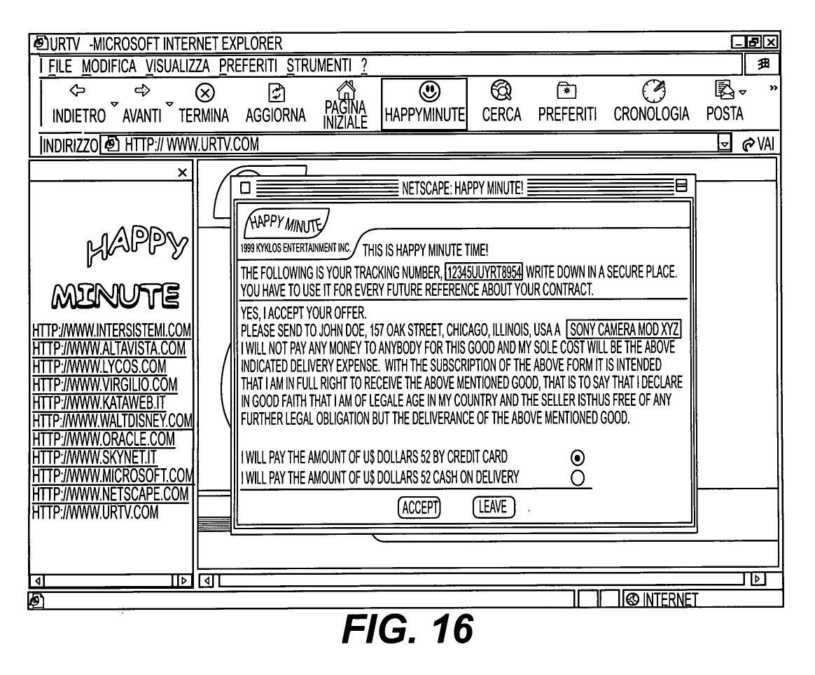

If the consumer enters all of the requested contract data and continues with the sign-in process, then an acceptance form (such as that shown in FIG. 16) may be displayed to the consumer (S.50). The acceptance form may display a tracking number that is generated for each transaction with the consumer. The tracking number can be used by the consumer in the future when contacting the site administrator or offeror with questions regarding, for example, the contract or delivery of goods. As illustrated in FIG. 16, the acceptance form may also include or display the type of product or service to be accepted, and the cost of the transaction, including, for example, the delivery, or other cost to be paid by the consumer. Moreover, the acceptance form may indicate, in unambiguous terms, that the consumer accepts each and every one of the terms of the transaction. In order to accept the displayed terms of the offer, the consumer may be requested to confirm acceptance of the terms by selecting a predetermined icon (such as an icon labeled “Accept” or “I ACCEPT”). Alternatively, the acceptance form could include an icon automatically labeled with the consumer's entered name that must be selected by the consumer to accept the offer. On the other hand, the consumer could still decline to accept the offer by selecting another predetermined icon (such as an icon labeled “Leave” or “I DECLINE”).

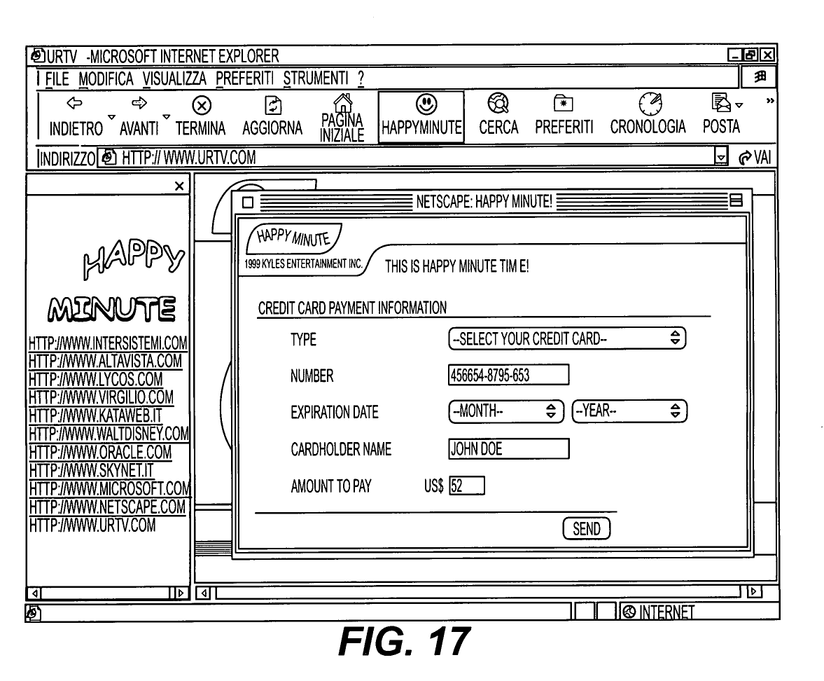

As shown in FIG. 27, if the consumer continues with the sign-in process and confirms acceptance, then the process may continue and the consumer may be provided with a payment request form (S.60). The payment request form displayed to the consumer may be a credit card data entry form, such as that illustrated in FIG. 17. With such a form, each consumer who pays by credit or debit card can enter payment data, such as the credit card account number, account limit, name of issuing institution and expiration date. Alternatively, any other payment method and request form may be utilized.

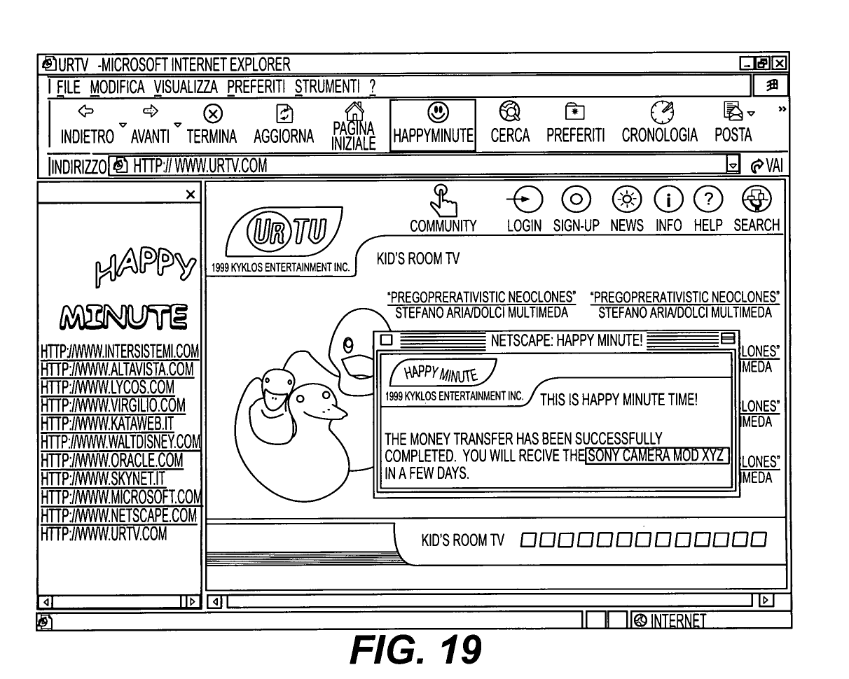

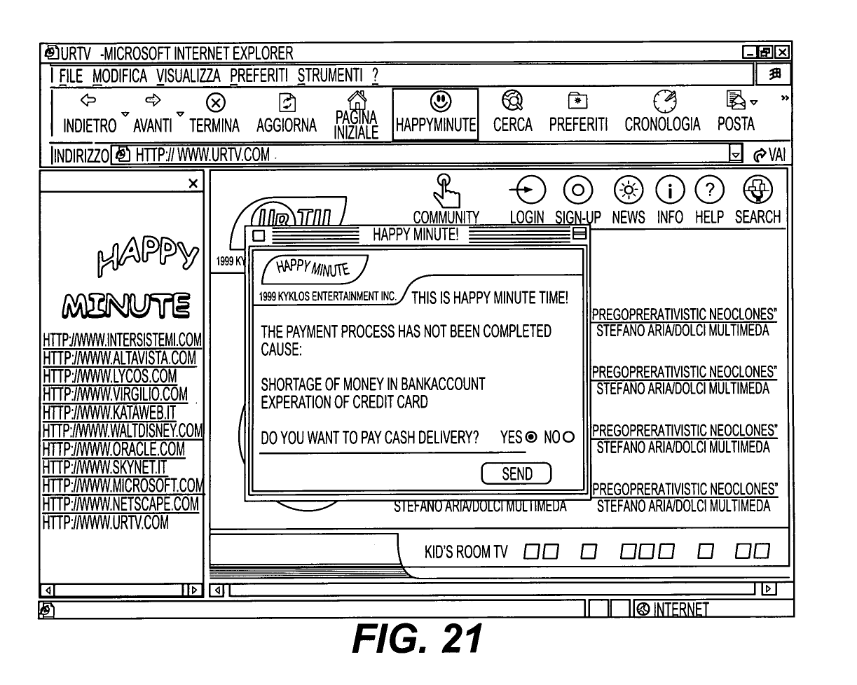

The payment information received from the consumer may be analyzed by the administrator interface 200 before the sale is completed. For example, the administrator interface 200 may contact a payment source, such as a bank or a credit card issuer, to confirm that the payment information is valid and that the appropriate amount of credit funds is available. If the payment information provided by the consumer is valid, then the administrator interface 200 may establish a consumer account with a record of the money transferred from the consumer. The administrator interface 200 may also notify the consumer of the successful completion of the money transfer (S.70) by generating a confirmation screen on the Web site (such as the illustrated embodiment of FIG. 19). Thereafter, the administrator interface 200 may complete the product offer transaction with the consumer by delivering or shipping the agreed-upon product to the consumer's address (S.80). If, however, the payment information provided by the consumer is invalid, the administrator interface 200 may automatically notify the consumer of the unsuccessful completion of the payment process (S.65). In one embodiment, a message screen may be displayed on the content Web site (such as that illustrated in the embodiment of FIG. 21) to inform the consumer that the payment process has not been completed. This message screen may indicate the cause of the incomplete payment process (such as exceeding the amount of available credit, a shortage of funds, or an invalid credit card number) and provide the consumer with the option to make payment (if any) upon receipt of the product or service (S.75). Other alternative payment methods may also be displayed.

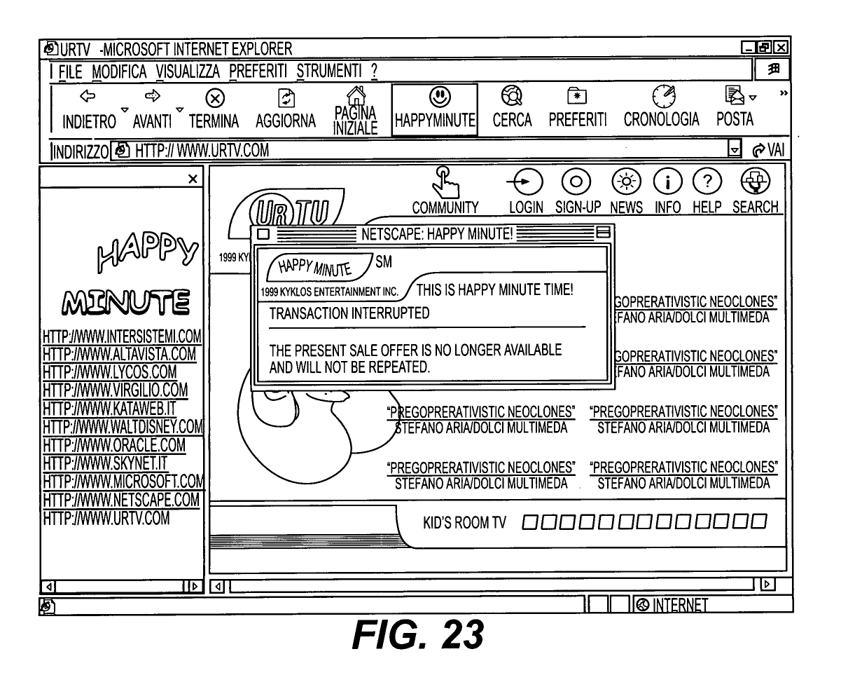

In the event that the consumer is given an option to use an alternative payment method (S.75), the consumer may indicate their selection to continue or terminate the product offer transaction. For example, in order to select a particular payment option (such as payment upon delivery or “C.O.D.”), the consumer need only select a predetermined icon (such as an icon labeled “Yes”) in response to the inquiry. In response to the consumer's decision to accept the alternative payment method, the product offer transaction may be completed as normal (S.80). If, however, the consumer does not select an alternative payment method and decides to reject the product offer (by selecting an icon labeled “No” or “Leave”), then the administrator interface 200 terminates the product offer transaction with the consumer. In such a case, the consumer may receive a warning message (such as that illustrated in FIG. 24) of the cancellation of the product offer or, if the time period for the product offer has expired, the consumer may receive a message (such as that illustrated in FIG. 23) that the product offer was terminated. Either the warning message or the cancellation announcement informs the unsuccessful consumer that the transaction has been interrupted and the conditional product offer is no longer available and will not be repeated. At this point, the transaction is considered null and void, with the conditional offer being rescinded by the offeror.

Various modifications may be made to the embodiment shown in FIG. 27. For example, alternative warning messages or information screens, that provide other types of helpful information to the consumer or potential consumer may also be displayed by the administrator interface 200. For example, a consumer may be informed that the offer is not rescinded unless a particular payment option is selected within a stated amount of time. The consumer may also be made aware of the time remaining to accept a product offer. Moreover, the amount of remaining products or services (if applicable) may also be displayed to the consumer. Additionally, information about successful consumer transactions may be displayed to the unsuccessful consumer.

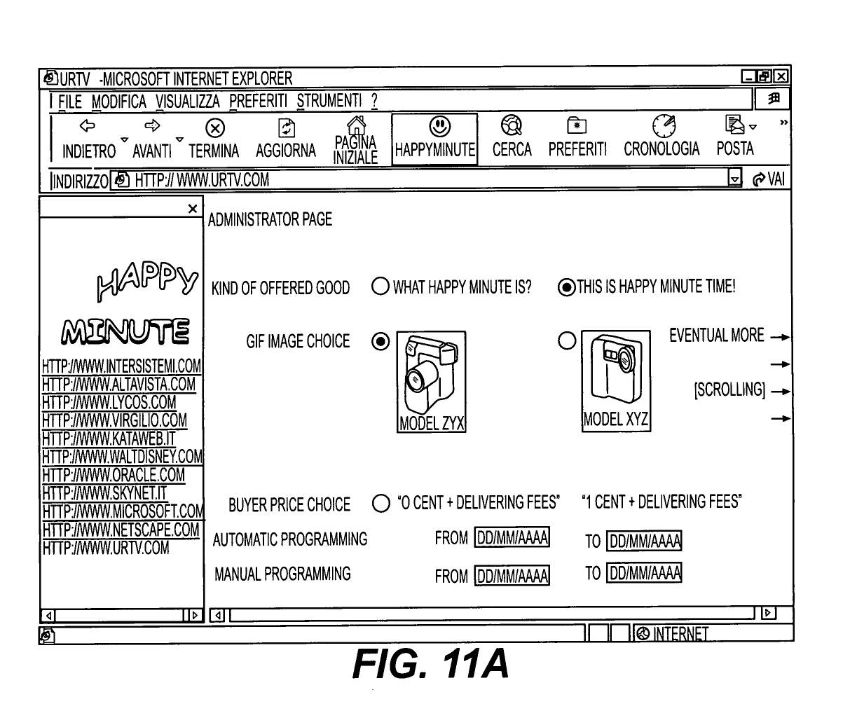

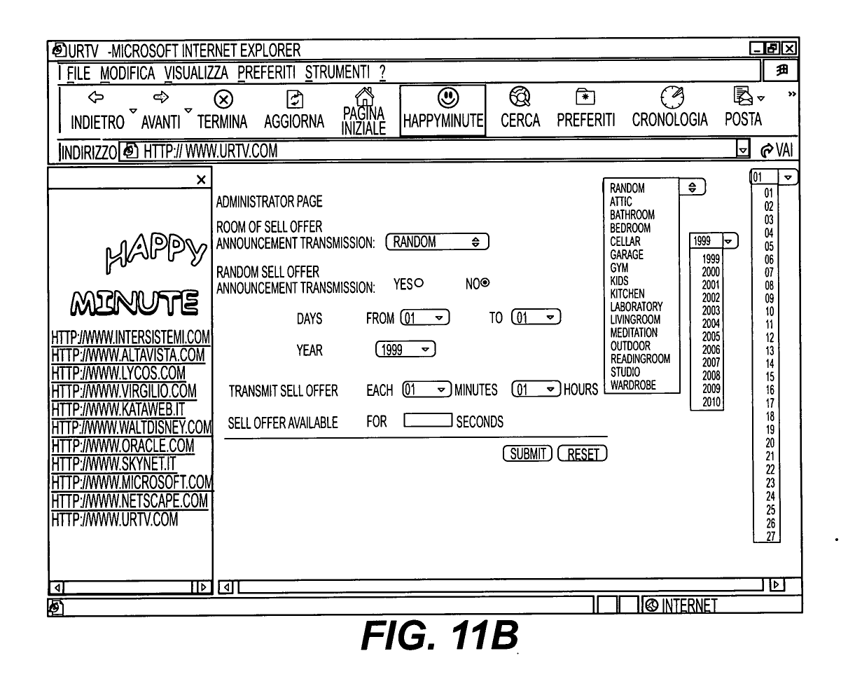

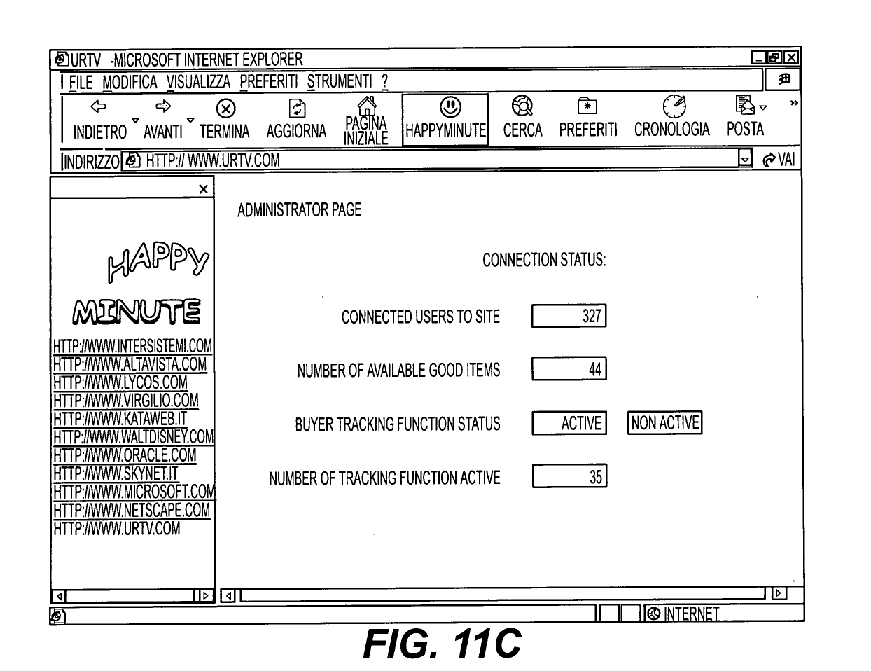

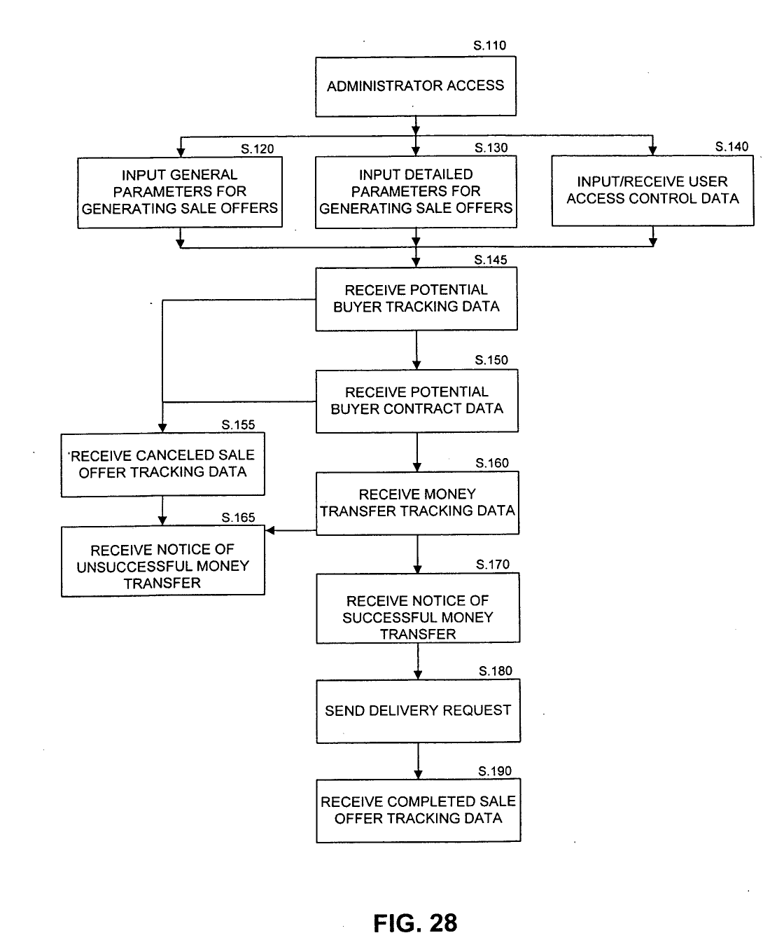

FIG. 28 is a flow chart of an exemplary method that illustrates the various features and operations that are performed by the offeror or Happy Minute® Network content Web site owner (herein referred to as the “Happy Minute® Network administrator” or “site administrator”) for generating and completing product offer transactions with consumers. As illustrated in FIG. 28, the Happy Minute® Network site administrator may log on to the administrator interface 200 (step S.110) to access one or more administrator pages during any stage of a product offer transaction. The administrator pages may be displayed on the site administrator's interface and be used to control the operation of the product offer system and the features of the product offer. To access the administrator pages, the site administrator may log on to the administrator interface 200 through a local connection or over the network system from a remote location (such as the offeror interface 300). With the administrator pages, such as those shown in FIGS. 11A-11C, the site administrator may manually program or select the number of people that will receive a product offer during any period of time. Moreover, the site administrator may select the type or number of products or services to be offered, the amount of the purchase price of the product or service, and the duration of the conditional offer or product offer. The Happy Minute® Network site administrator may also determine the kind of data needed to be received from the consumer in order to consummate the sale.

The administrator pages of the present invention may also be used to provide information to the consumer or site administrator. For example, as further described herein, the administrator interface 200 may be automatically or manually programmed by the site administrator to provide the consumer with information about the Web site and/or the product offer. The administrator pages may also receive and display information from the administrator interface 200 and inform the site administrator of various operational characteristics related to the product offer system, such as the number of people visiting the Web site or the number of people that can receive the product offer at any given point in time.

Referring again to FIG. 28, after the Happy Minute® Network site administrator has accessed the administrator interface 200 and administrator pages (S.110), various tasks may be performed by the site administrator. For example, the site administrator may manually program one or more of the features of the product offer by entering general or detailed product offer parameters (S.120, S.130). For example, if an administrator page, such as that shown in FIG. 11A is provided, the site administrator may manually enter and program general parameters relating to the product offer (S.120), such as the type of product or service to be provided, the image to be displayed with the offer, and the pricing or purchasing terms for the goods or services (e.g., “0 cent+delivering fees” or “1 cent+delivering fees”). Other general parameters related to the product offer may also be entered by the site administrator, such as the time or manner in which the product offer is generated. For instance, an automatic or manual programming option may be selected (see FIG. 11A) to indicate the time period (e.g., between a start date and an ending date) during which the generation of the product offers is to be automatically or manually programmed.

The Happy Minute® Network site administrator may also manually enter and program detailed parameters relating to the product offer (S.130). For example, if an administrator page, such as that illustrated in FIG. 11B is provided, the site administrator may enter the specific location and timing for generating the product offers. Since product offers may be displayed on any page or room of the Web site, the site administrator may specify a particular room location for generating the product offers or program the administrator interface 200 to generate the product offer in any randomly selected number of room locations. The site administrator may also program the administrator interface 200 so that the product offers are generated at randomly selected times or a predetermined frequency over a defined time period.

Access to the administrator interface 200 and administrator pages can also permit the Happy Minute® Network site administrator to input or receive consumer access control data (S.140). For example, with an administrator page, such as the embodiment illustrated in FIG. 11C, the site administrator may receive a report on the status of the Web site at any given moment, including the number of registered consumers connected to the site, the number of available products or services to provide through the product offers, whether a consumer tracking function status is active or inactive, and the number of active tracking functions. The information provided to the site administrator could also indicate the number of people who are eligible to receive a conditional offer (as described herein below) or product offer. Preferably, the information provided to the site administrator is updated and displayed in real time. However, other embodiments may include displaying various types of statistical data, based on data collected for selected time periods or any other type of variable, such as the number of Web site “hits” during a particular pattern of product offers. In addition, information provided to the site administrator may indicate the amount of remaining time each potential consumer has to respond to a particular product offer, or the particular room in which particular consumers are visiting. Moreover, the information displayed could allow the site administrator to profile particular Web site registered consumers and match suitable types of product offers accordingly. For example, a product or service for use in the kitchen could be conditionally offered to a registered consumer who is visiting, has visited, and/or will likely visit a particular Happy Minute® Network Web site. In general, the present invention may involve conditionally offering products that are specifically related to the content of the Web site.

In accordance with the invention, each conditional offer or product offer may be made available to all registered consumers that are currently visiting the Happy Minute® Network Web site or are in any way exchanging information with the Web server or administrator interface 200. Thus, consumers (even though registered) who are viewing information from the Web site in an off-line browsing or cached browsing mode will not receive or be able to view the product offer. Further, in some cases, the capacity of the Web server or administrator interface 200 may be limited so that only a predetermined number of consumers (e.g., 200 consumers) can receive the product offer at any given time. Alternatively, a limited number of product offers (not necessarily restricted by the capacity of the server or controller but selected by the offeror) may be provided to consumers visiting and exchanging information with the Web site when the offer is to be made. In such a case, the product offer may expire prior to the duration or period of the offer, if all of the predetermined product offers have been accepted by consumers who received the offer through the Web site.

It is also possible to target particular registered consumers, so that only those consumers who have a certain profile or other type of identifier that matches a predetermined profile, characteristic, or identifier selected by the offeror can actually receive the product offer. It is possible to target consumers by any demographically-related indicia, and it is further possible to target one or more individuals by name, for example, to reward frequent consumers, or recognize those who have performed a noteworthy public service. This type of targeting can be accomplished by means of setting additional parameters associated with the generation of product offers. With such a targeted approach, the offeror or site administrator may target specific types of consumers with the product offer. The profile of each consumer may be determined by the administrator interface 200 based on historical and/or statistical data of visitations to the Web site (or other Web sites) by the consumer or a related consumer group. Alternatively, the profile of a consumer may be determined by the administrator interface 200 by searching and gathering information from one or more internal or external databases, such as consumer database 255 and product offer database 258 stored in data storage device 250.

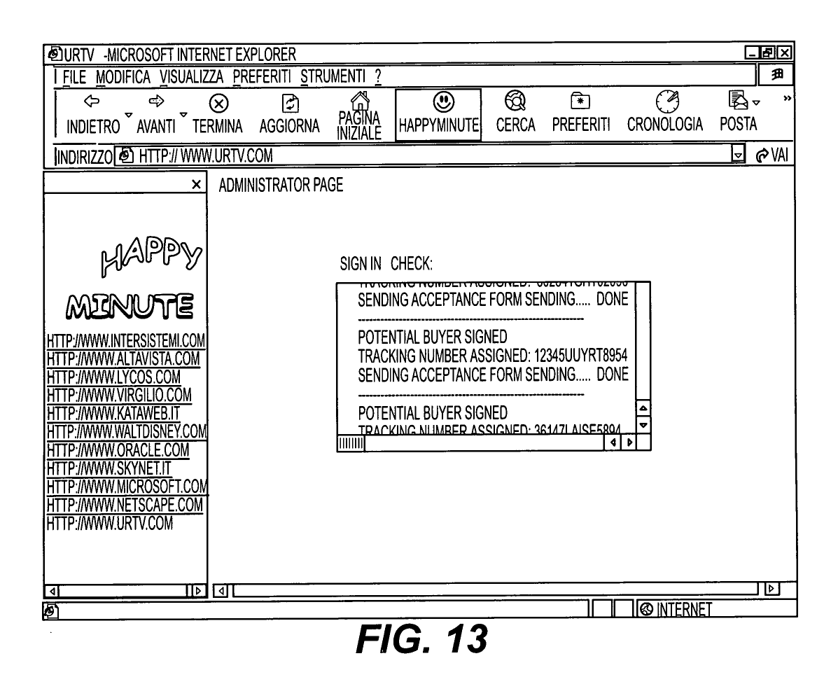

According to the product offer parameters entered by the site administrator, the administrator interface 200 will generate the product offer at one or more locations in the Happy Minute® Network Web sites. As discussed above, a pop-up screen or window may be generated (see, e.g., FIG. 12) to notify potential consumers visiting such Web sites of the product offer. In essence, each Web site visitor will be given a choice between accepting the offer (subject to certain conditions) or rejecting the offer. As shown in FIG. 12, to preliminarily accept the offer, the potential consumer must select an icon labeled “Sign-In.” To decline the offer, the potential consumer may select an icon labeled “Leave” or fail to accept the offer within the predetermined period of time set by the site administrator. For all potential consumers that sign in, tracking data may be collected by the administrator interface 200 and provided to the site administrator (S.145). The tracking data for each consumer, which can be presented to the site administrator through an additional administrator page (see, e.g., FIG. 13), may include a log of the actions performed by the potential consumer (e.g., “potential consumer signed”) and the tracking number assigned by the administrator interface 200 (e.g., “12345uuyrt8954”). In operation, the administrator interface may automatically assign a unique tracking number for each product offer transaction with a consumer. In addition, the administrator interface 200 may time-stamp the preliminarily accepted offer from the consumer, and then store the time-stamped data for purposes of record keeping.

When a potential registered consumer decides to sign in, the administrator interface 200 causes a product offer information page to be served up and displayed to the consumer. The information page (see, e.g., FIG. 14) may provide more detailed and helpful information regarding the product offer, such as the type of product or service offered, as well as the terms of the offer. If a potential consumer decides to continue with the sign-in process, one or more contract data entry forms and acceptance forms may be displayed to request contract data (such as name, address, etc.) and confirmation of the acceptance of the product offer by the consumer. The data entry forms preferably comply with relevant contract law principles and, as such, constitute an electronic contract with a number of particular blanks to be intentionally filled out or completed by the consumer. This information may be provided to the potential consumer to indicate the purpose of the forms and confirmation. Additionally, the potential consumer may be informed that such information could be treated adequately and in accordance with relevant privacy guidelines, such as set forth in the European Data Directive or other applicable law.

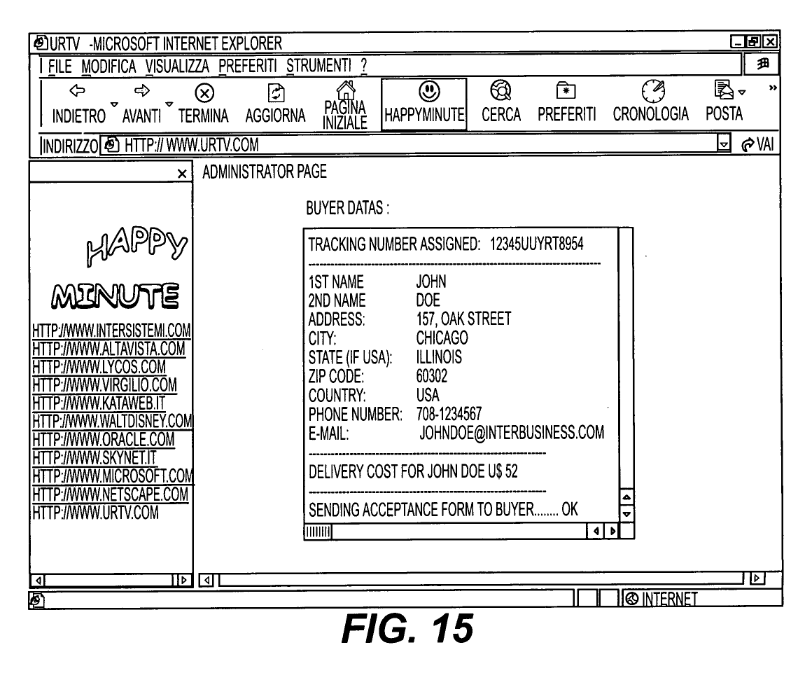

As further shown in FIG. 28, any contract data or confirmation entered by the potential consumer may be received and viewed by the Happy Minute® Network site administrator (S.150). For this purpose, an administrator page may be provided (such as shown in the embodiment illustrated in FIG. 15) to indicate to the administrator the contract data and confirmation that was received by the administrator interface 200 from the potential consumer. During the sign-in transaction, the potential consumer may decline to accept the offer simply by pressing a predetermined icon (such as an icon labeled “Leave”). If the potential consumer leaves the sign-in process before providing all of the requested contract data, then the central processor registers the leave selection and informs the potential consumer that the transaction has been closed and that the offer is no longer available. In such cases, the site administrator is also informed whenever a potential consumer has terminated the sign-in process or declined to accept the offer (S.155).

If the potential consumer provides all of the necessary contract data and confirms acceptance of the contract terms, then the administrator interface 200 receives and communicates the consumer's acceptance of the product offer to the offeror or administrator viewing through another administrator page. Next, a credit card data entry form is served up by the administrator interface 200 and displayed on the consumer interface 400. In a preferred embodiment of the invention, the payment process begins when the consumer completes the credit card data entry form and selects the icon labeled “Send.” The consumer who pays by credit card, preferably enters payment data such as the credit card account number, account limit, name of issuing institution and expiration date. Alternatively, any other payment method may be utilized. When the requested payment information is to be sent from the consumer, the administrator interface 200 may perform an encryption operation by using any known encrypting protocol on the entered payment data. Such encryption protocols not only enhance the ability to authenticate the sender of a message, but also serve to verify the integrity of the message itself, proving that it has not been altered during transmission. Such techniques are referred to herein generally as cryptographic assurance methods, and will include the use of both symmetric and asymmetric keys as well as digital signatures and hash algorithms. The practice of using cryptographic protocols to ensure the authenticity of senders as well as the integrity of messages is well known in the art and need not be described here in detail. For reference, one of ordinary skill in the art may refer to, for example, Bruce Schneier, Applied Cryptography, Protocols, Algorithms, And Source Code In C, (2d Ed, John Wiley & Sons, Inc., 1996).

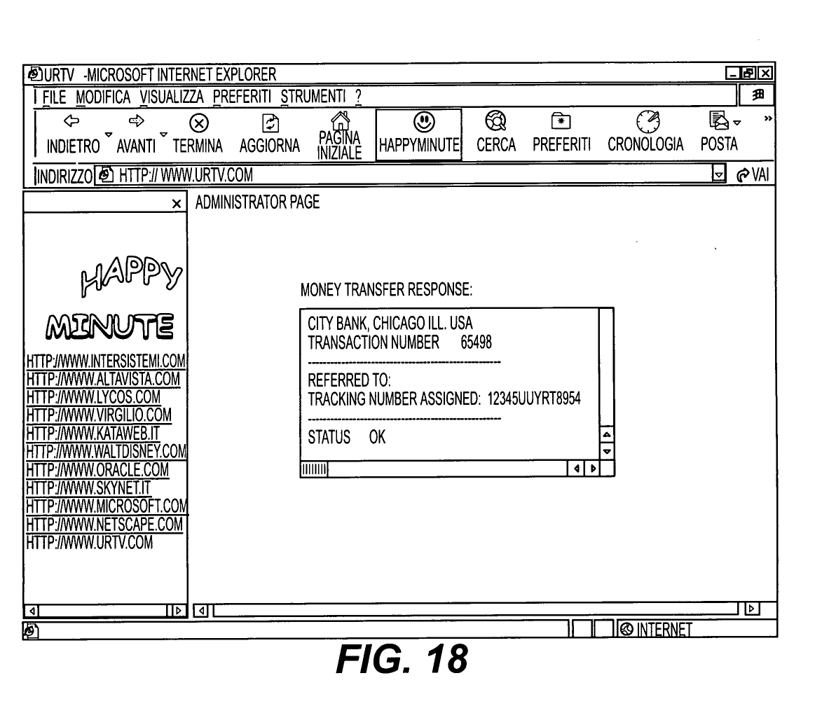

In order to verify the payment information received from the consumer, the administrator interface 200 may contact a payment source, such as a bank or a credit card issuer, to confirm that the payment information is valid and that the credit amount or appropriate funds are available. Accordingly, a consumer is prevented from using a credit card with an exceeded credit limit, or a debit card with insufficient funds to establish a consumer account. During this verification process, the administrator interface may generate and display money transfer response data for viewing by the Happy Minute® Network site administrator (S160). Through an administrator page (see, e.g., the exemplary embodiment of FIG. 18), the site administrator may monitor the progress and status of the money transfer attempted by the administrator interface 200. If the money transfer is successful, then the administrator interface 200 may automatically establish a consumer account and notify the consumer of the successful transaction. In addition, a notification of the transaction may be provided to the site administrator through an administrator page (S.170). Thereafter, the administrator interface 200 completes the sale transaction by generating a delivery request so that the purchased goods or services will be timely delivered to the consumer. The delivery request may be automatically generated and sent by the administrator interface 200, or each delivery request from the administrator interface 200 may be reviewed and confirmed by the site administrator before it is sent to an agent of the offeror for processing. For this purpose, each delivery request may be received and viewed by the site administrator through an administrator page (see, e.g., the exemplary embodiment of FIG. 20) before the delivery request is sent (S.180). Any completed product offer tracking data may also be provided and viewed by the site administrator (S.190). This may be performed after the limited period for the product offer has terminated, so that the site administrator can review the results of the product offer and the number of sale transactions that were successfully completed.

Referring again to FIG. 28, if the attempt to transfer money fails (e.g., due to an invalid credit card number, exceeded credit limit, or insufficient funds), then the consumer is informed of the failed transaction. The administrator interface 200 may also provide notice of the failed money transaction to the site administrator (S.165). Once again, an administrator page may be provided to provide such information to the site administrator. Preferably, the notification to the consumer informs the consumer of the cause of the incomplete payment process and provides the consumer with the option of choosing one or more alternative payment methods, such as cash payment upon delivery. If the consumer refuses to select an alternative payment method within a predetermined period of time, then the administrator interface 200 may display a warning or sale cancellation message to indicate to the consumer that the conditional offer is no longer available and has been rescinded.

Other embodiments of the invention will be apparent to those skilled in the art from consideration of the specification and practice of the invention disclosed herein. For example, product offers may be made to registered consumers who are browsing any Web page, including those outside the associated sites or Happy Minute® Network sites. Furthermore, although the process of downloading and installing a plug-in has been described, it is also possible to construct a Web browser so that it inherently includes the same functionality as that provided by a separate plug-in. In addition, a special room or page may be provided indicating the group of goods or services from which product offers will be made, and/or the day, week, or month when such product offers can be expected to be offered. Such an arrangement will permit consumers to view the types of goods or services that will be made available and, optionally, to anticipate or know the day, week, or month or other general time period during which such goods and services will be offered through the Web site.

Additional alterations and modifications of the present invention will be comprehended by a person skilled in the art after having read the foregoing description.

Therefore, it is intended that the specification and examples be considered as exemplary only and it should be understood that the invention is not limited to the illustrative examples in this specification. Rather, the invention is intended to cover all modifications and variations that come within the scope of the following claims and their equivalents.

What is claimed is:

1. A method comprising the steps of:
receiving information regarding at least one product offered at no cost from one or more vendors;
indicating, on a Web site, the availability of the at least one product for a transient period of time, which is unpredictable by individuals viewing the Web site; and
providing at least one of the individuals viewing the Web site with the at least one product, at a price equal to or less than a delivery cost associated with delivering the at least one product to the at least one individual.

2. The method of claim 1, further comprising:
providing the one or more vendors with information regarding the Web site, wherein the information regarding the Web site includes one or more of visitor demographic information, usage information, content information, and advertising information.

3. The method of claim 1, further comprising:
displaying information regarding the at least one product on the Web site, wherein the information regarding the at least one product includes one or more of a brand, a model number, a name, a product identification code, a production cost, a suggested retail price, a size, a weight, and an image of the product.

4. The method of claim 3, wherein indicating the availability of the at least one product on the Web site includes one or more of displaying the product in a pop-up advertisement, displaying the product in an unused area of the Web site, and displaying the product as part of an offer that can be accepted by an individual viewing the Web site.

5. The method of claim 1, wherein the method is implemented for at least one of:
increasing the amount of time spent by individuals viewing the Web site;
increasing traffic on the Web site;
providing the one or more vendors with targeted advertising;
increasing targeted exposure of the at least one product;
creating an online marketplace; and
facilitating a sweepstakes over an electronic network system.

6. A method comprising the steps of:
providing a vendor with information regarding a Web site;
receiving from the vendor electronic information regarding one or more products offered by the vendor; and
providing the vendor with a promise in exchange for receipt of the one or more products;
wherein the promise includes promising to the vendor that the one or more products will be provided to a visitor of the Web site at a price equal to or less than a delivery cost associated with delivering the one or more products to the visitor.

7. The method of claim 6, further comprising the step of creating an offer to a visitor of the Web site, which the visitor may accept in order to be provided with the one or more products.

8. The method claim 7, further comprising the step of receiving the one or more products from the vendor and forwarding the one or more products to a visitor who has accepted the offer.

9. The method of claim 6, wherein the promise further includes promising to the vendor that the one or more products will be displayed in an advertisement on the Web site.

10. The method of claim 9, wherein the advertisement is displayed on an advertising space on the Web site.

11. The method of claim 6, wherein the method is implemented for at least one of:
increasing the amount of time spent by individuals viewing the Web site;
increasing traffic on the Web site;
providing the vendor with targeted advertising;
increasing targeted exposure of the one or more products;
creating an online marketplace; and
facilitating a sweepstakes over an electronic network system.

12. A method comprising the steps of:
electronically providing a vendor with information regarding a plurality of Web sites;
electronically receiving from the vendor the identity of a preferred one of the Web sites;
electronically receiving from the vendor an offer to provide at least one product at no cost to at least one visitor of the preferred one of the Web sites; and
physically providing the at least one product at no cost to at least one visitor of the preferred one of the Web sites.

13. The method of claim 12, wherein the information regarding the plurality of Web sites includes one or more of visitor demographic information, usage information, content information, and advertising information.

14. The method of claim 12, further comprising:
receiving information regarding the at least one product from the vendor; and
displaying the information regarding the at least one product on the preferred one of the Web sites.

15. The method of claim 14, wherein the information regarding the at least one product includes one or more of a brand, a model number, a name, a product identification code, a production cost, a suggested retail price, a size, a weight, and an image of the product.

16. The method of claim 12, further comprising:
displaying an offer on the preferred one of the Web sites for a transient period of time unpredictable by visitors of the preferred one of the Web sites, the offer including an offer to provide the at least one product to at least one visitor of the Web site at no cost to the visitor.

17. The method of claim 12, wherein the method is implemented for at least one of:
increasing the amount of time spent by individuals viewing the preferred one of the Web sites;
increasing traffic on the preferred one of the Web sites;
providing the vendor with targeted advertising;
increasing targeted exposure of the at least one product;
creating an online marketplace; and
facilitating a sweepstakes over an electronic network system.

18. A method comprising the steps of:
receiving information regarding a plurality of Web sites;
selecting a preferred one of the Web sites based on the received information; and
providing at least one product to an agent of the preferred one of the Web sites in exchange for a guarantee;
wherein the guarantee includes:
a guarantee from the agent that product information regarding the at least one product will be displayed on the preferred one of the Web sites; and
a guarantee that the at least one product provided to the agent will be provided to at least one visitor of the preferred one of the Web sites, at a price equal to or less than a cost associated with delivering the at least one product to the at least one visitor.

19. The method of claim 18, wherein the guarantee further includes a guarantee that the at least one product will be offered to visitors of the preferred one of the Web sites for a transient period of time unpredictable by the visitors.

20. The method of claim 18, further comprising the step of providing product information regarding the at least one product to the agent of the preferred one of the Web sites.

21. The method of claim 20, wherein the product information includes one or more of a brand, a model number, a name, a product identification code, a production cost, a suggested retail price, a size, a weight, and an image of the product.

22. The method of claim 18, wherein the information regarding the plurality of Web sites includes one or more of visitor demographic information, usage information, content information, and advertising information.

23. The method of claim 18, wherein the method is implemented for at least one of:
increasing the amount of time spent by individuals viewing the preferred one of the Web sites;
increasing traffic on the preferred one of the Web sites;
providing targeted advertising for the at least one product;
increasing exposure for the at least one product;
creating an online marketplace; and
facilitating a sweepstakes over an electronic network system.

24. A system comprising:
a communication device configured to receive information about a content Web site from an offeror; and receive information about a product from a vendor;
a data storage device configured to receive information from the communication device; and
a processor connected to the data storage device, wherein said data storage device stores a program for controlling the processor, and said processor is operative with the program for:
providing a central Web site operable by an administrator; and
providing a product display and offer proposal to the offeror and vendor;
wherein the product display and offer proposal includes:
the offeror displaying the product on the content Web site for a transient period of time unpredictable by consumers visiting the content Web site;
the offeror offering the product at no cost to at least one consumer visiting the content Web site; and
the vendor supplying the product at no cost to one of the administrator, the offeror, and the consumer.

25. The system of claim 24, wherein the processor is configured to provide the product display and offer proposal at least partially defined by variables including one or more of a time during which the product is displayed, a frequency with which the product is displayed, an amount of information displayed about the product, and a portion of the content Web site on which the product is displayed.

26. The system of claim 24, wherein the communication device is configured to receive information about the content Web site including one or more of visitor demographic information, usage information, content information, and advertising information.

27. The system of claim 24, wherein the communication device is configured to receive information about the product including one or more of a brand, a model number, a name, a product identification code, a production cost, a suggested retail price, a size, a weight, and an image of the product.

28. The system of claim 24, wherein the system is implemented for at least one of:
increasing the amount of time spent by individuals viewing the content Web site;
increasing traffic on the content Web site;
providing the vendor with targeted advertising;
increasing targeted exposure for the product;
creating an online marketplace; and
facilitating a sweepstakes over an electronic network system.

29. A system comprising:
a data storage device; and
a processor connected to the data storage device, wherein said data storage device stores a program for controlling the processor, and said processor is operative with the program for:
providing a central Web site operable by an administrator;
providing a vendor of products with information about a plurality of content Web sites, via the central Web site;
providing an agent for one of the content Web sites with information about products available from the vendor, via the central Web site;
displaying the products on one of the content Web sites for a transient period of time unpredictable by visitors to the content Web site; and
making an offer to provide the products at no cost to one or more consumers who view the displayed products during the transient period of time.

30. The system of claim 29, wherein the processor is further configured to facilitate a delivery of at least one of the products from the vendor to at least one of the consumers who accept the offer.

31. The system of claim 29, wherein the processor is further configured to facilitate the exchange of information regarding the product and the Web site between the vendor and the agent, via the central Web site.

32. The system of claim 29, wherein the processor is further configured to facilitate the exchange of information regarding the product between the vendor and consumers, via the central Web site.

33. The system of claim 29, wherein the system is implemented for at least one of:
increasing the amount of time spent by individuals viewing one of the content Web sites;
increasing traffic on one of the content Web sites;
providing the vendor with targeted advertising;
increasing targeted exposure of the products;
creating an online marketplace; and
facilitating a sweepstakes over an electronic network system.

34. A method comprising the steps of:
visiting a Web site operated by an offeror;
electronically providing the offeror with personal demographic data;
viewing a display of a product on the Web site, the display offering to provide the product to visitors of the website at a cost equal to or less than a delivery cost associated with delivering the product to a visitor who accepts the offer;
electronically accepting the offer from the offeror; and
physically receiving the product from a vendor that provided the offeror with instructions for displaying the product on the Web site.

35. The method of claim 34, wherein the personal demographic data includes one or more of a name, address, telephone number, citizenship, birth date, age, ethnicity, gender, personal interests, occupation, income, educational history, shopping habits, and commercial preferences.

36. The method of claim 34, wherein the step of accepting the offer from the offeror further includes providing the offeror or the vendor with one or more of payment information and delivery information.
